(19) United States
(12) Patent Application Publication
(10) Pub. No.: US 2004/0126749 A1
(43) Pub. Date: Jul. 1, 2004

(54) Educational method and system by utilizing historical informations

(76) Inventors: Hayato Honma, Yokohama-shi (JP); Yuriko Kawai, Yokohama-shi (JP); Takeshi Kobayashi, Yokohama-shi (JP); Hideki Nakano, Torrance, CA (US)

Correspondence Address: LAW OFFICE OF RICHARD A. DUNNING, JR., 343 SOQUEL AVENUE, SUITE 311, SANTA CRUZ, CA, 95062, US

(21) Appl. No.: 10/680,001

(22) Filed: Oct. 6, 2003

(30) Foreign Application Priority Data
Oct. 4, 2002 (JP) 2002-293101

(51) Int. Cl. G09B 19/00; G09B 7/00

(52) U.S. Cl. 434/362; 434/350; 434/118

(57) ABSTRACT

Educational system and method of utilizing a learning history information are provided. At least one student's account is provided with at least one subject-related information, which has been classified in a designated field and registered in a data base. At least one teacher's account is provided with at least one student-prepared essay information with an edition-number-related information, which corresponds to the at least one subject-related information. A registration is made of the at least one student-created essay information into the data base, in combination with a teacher-providing evaluation record information and a designated-field-related information.

### BACKGROUND OF THE INVENTION

1. Field of the Invention

The present invention relates to educational method and system by utilizing historical informations, and more particularly to educational method and system by utilizing historical informations

2. Description of the Related Art

All of patents, patent applications, patent publications, scientific articles and the like, which will hereinafter be cited or identified in the present application, will, hereby, be incorporated by references in their entirety in order to describe more fully the state of the art, to which the present invention pertains.

The advent of the computer has led to the introduction of the Information Technology (IT) into education, like CAI systems. Moreover, a large number of educational techniques have already been proposed as e-learning, depending upon a recent wide spread of the Internet. The past-proposed educational techniques are to deliver teaching materials including texts and motion pictures, to students through a variety of existent delivery means such as post-mail transmission, facsimile transmission, and the Internet transmission, thereby to enable the students to try to solve some drill-type questions in time series for subsequent confirmatory tests. Use of this method has achieved certain successful results, particularly as a result of repetitive learning in the fixed range of the questions, for example, English examinations and qualifying examinations. One of the conventionally proposed educational techniques is disclosed in the Internet Web-Site, entitled “Fujitsu Info Software Technologies Web Site” since 1997, managed by Fujitsu Info Software Technologies Limited, at Internet <URL: http://naving.fsel.co.ip/index.html>.

In the above-described circumstances, recently, the Japan's governmental policy of education has been changed, and “e-JAPAN” project has been planed by the Japanese government. The request by the Japanese nations for the education has also been changed along with a recent remarkable change to recent broadband communications from the past narrowband communications. The educational environment has also been improved to allow any people to learn anytime and anywhere, so called to as “Ubiquitous”. Learning opportunities have not been limited to schools.

Globalization including the recent wide-spread of the Internet provides not only hardware communications inter-connecting between IT-instruments but also frequent opportunities of human communications. The requirement for collaborative leaning with fellow students has been on the increase.

It is also desirable to use some leaning histories for introducing knowledge management into the scene of education through portfolio learning useful for making data bases of leaning processes.

It has been required to solve the above-described educational issues. It has also been required to provide a novel technique of discovering each individual ability and talent, wherein the novel technique is adjusted to the scene of education and other curriculums such as comprehensive learning and paper-writing learning than predetermined learning textbooks, even it is difficult to discover such individual ability and talent through the confirmatory tests.

In the above circumstances, the development of a novel educational method and system utilizing learning-history informations free from the above problems is desirable.

### SUMMARY OF THE INVENTION

Accordingly, it is an object of the present invention to provide a novel educational method by utilizing learning-history informations free from the above problems.

It is a further object of the present invention to provide a novel educational method by utilizing learning-history informations, wherein the method allows the learning-history informations to be re-useable, retrievable and storable.

It is a still further object of the present invention to provide a novel educational method by utilizing learning-history informations, wherein the method is available anywhere.

It is yet a further object of the present invention to provide a novel educational method by utilizing learning-history informations, wherein the method is suitable for a student to learn in cooperation with other students.

It is moreover object of the present invention to provide a novel educational system by utilizing learning-history informations free from the above problems.

It is another object of the present invention to provide a novel educational system by utilizing learning-history informations, wherein the method allows the learning-history informations to be re-useable, retrievable and storable.

It is still another object of the present invention to provide a novel educational system by utilizing learning-history informations, wherein the method is available anywhere.

It is yet another object of the present invention to provide a novel educational system by utilizing learning-history informations, wherein the method is suitable for a student to learn in cooperation with other students.

In accordance with the present invention, educational system and method of utilizing a learning history information are provided. At least one student's account is provided with at least one subject-related information, which has been classified in a designated field and registered in a data base. At least one teacher's account is provided with at least one student-prepared essay information with an edition-number-related information, which corresponds to the at least one subject-related information. A registration is made of the at least one student-created essay information into the data base, in combination with a teacher-providing evaluation record information and a designated-field-related information.

The above and other objects, features and advantages of the present invention will be apparent from the following descriptions.

### BRIEF DESCRIPTION OF THE DRAWINGS

Preferred embodiments according to the present invention will be described in detail with reference to the accompanying drawings.

FIG. 1 is a block diagram illustrative of a configuration of a learning-history-information utilizing educational system in accordance with a preferred embodiment of the present invention.

FIG. 2 is a diagram illustrative of a configuration of a network including the learning-history-information utilizing educational system and other terminals connected each other through a communication network in accordance with the preferred embodiment of the present invention.

FIG. 3 is a diagram illustrative of a conceptional leaning process according to the learning-history-information utilizing educational method in accordance with the preferred embodiment of the present invention.

FIG. 4 is a diagram illustrative of another conceptional leaning process according to the learning-history-information utilizing educational method in accordance with the preferred embodiment of the present invention.

FIG. 5 is a flow diagram illustrative of the conceptional leaning process shown in FIGS. 3 and 4 according to the learning-history-information utilizing educational method in accordance with the preferred embodiment of the present invention.

FIG. 6 is a flow chart illustrative of sequential steps involved in the learning-history-information utilizing educational method in accordance with the preferred embodiment of the present invention.

FIG. 7 is a flow chart illustrative of another sequential steps involved in the learning-history-information utilizing educational method in accordance with the preferred embodiment of the present invention.

FIG. 8 is a flow chart illustrative of still another sequential steps involved in the learning-history-information utilizing educational method in accordance with the preferred embodiment of the present invention.

FIG. 9 is a flow chart illustrative of yet another sequential steps involved in the learning-history-information utilizing educational method in accordance with the preferred embodiment of the present invention.

FIG. 10 is a flow chart illustrative of further another sequential steps involved in the learning-history-information utilizing educational method in accordance with the preferred embodiment of the present invention.

FIG. 11 is a flow chart illustrative of furthermore sequential steps involved in the learning-history-information utilizing educational method in accordance with the preferred embodiment of the present invention.

FIG. 12 is a flow chart illustrative of still more sequential steps involved in the learning-history-information utilizing educational method in accordance with the preferred embodiment of the present invention.

FIG. 13 is a flow chart illustrative of yet more sequential steps involved in the learning-history-information utilizing educational method in accordance with the preferred embodiment of the present invention.

FIG. 14 is a flow chart illustrative of moreover sequential steps involved in the learning-history-information utilizing educational method in accordance with the preferred embodiment of the present invention.

FIG. 15A is a view illustrative of an example of Web-page layout involved in the learning-history-information utilizing educational method in accordance with the preferred embodiment of the present invention.

FIG. 15B is a view illustrative of another example of Web-page layout involved in the learning-history-information utilizing educational method in accordance with the preferred embodiment of the present invention.

FIG. 16 is a view illustrative of still another example of Web-page layout involved in the learning-history-information utilizing educational method in accordance with the preferred embodiment of the present invention.

FIG. 17 is a view illustrative of still another example of Web-page layout involved in the learning-history-information utilizing educational method in accordance with the preferred embodiment of the present invention.

FIG. 18 is a view illustrative of still another example of Web-page layout involved in the learning-history-information utilizing educational method in accordance with the preferred embodiment of the present invention.

FIG. 19 is a view illustrative of still another example of Web-page layout involved in the learning-history-information utilizing educational method in accordance with the preferred embodiment of the present invention.

FIG. 20 is a view illustrative of still another example of Web-page layout involved in the learning-history-information utilizing educational method in accordance with the preferred embodiment of the present invention.

FIG. 21 is a view illustrative of still another example of Web-page layout involved in the learning-history-information utilizing educational method in accordance with the preferred embodiment of the present invention.

FIG. 22 is a view illustrative of still another example of Web-page layout involved in the learning-history-information utilizing educational method in accordance with the preferred embodiment of the present invention.

FIG. 23 is a view illustrative of still another example of Web-page layout involved in the learning-history-information utilizing educational method in accordance with the preferred embodiment of the present invention.

FIG. 24A is a view illustrative of still another example of Web-page layout involved in the learning-history-information utilizing educational method in accordance with the preferred embodiment of the present invention.

FIG. 24B is a view illustrative of still another example of Web-page layout involved in the learning-history-information utilizing educational method in accordance with the preferred embodiment of the present invention.

FIG. 25 is a view illustrative of still another example of Web-page layout involved in the learning-history-information utilizing educational method in accordance with the preferred embodiment of the present invention.

FIG. 26 is a view illustrative of still another example of Web-page layout involved in the learning-history-information utilizing educational method in accordance with the preferred embodiment of the present invention.

FIG. 27 is a view illustrative of still another example of Web-page layout involved in the learning-history-information utilizing educational method in accordance with the preferred embodiment of the present invention.

FIG. 28 is a view illustrative of still another example of Web-page layout involved in the learning-history-information utilizing educational method in accordance with the preferred embodiment of the present invention.

FIG. 29 is a view illustrative of still another example of Web-page layout involved in the learning-history-information utilizing educational method in accordance with the preferred embodiment of the present invention.

FIG. 30 is graphs showing evaluation results of the education made through the learning-history-information utilizing educational method in accordance with the preferred embodiment of the present invention.

FIG. 31 is a view illustrative of still another example of Web-page layout involved in the learning-history-information utilizing educational method in accordance with the preferred embodiment of the present invention.

FIG. 32 is a view illustrative of still another example of Web-page layout involved in the learning-history-information utilizing educational method in accordance with the preferred embodiment of the present invention.

FIG. 33 is a view illustrative of still another example of Web-page layout involved in the learning-history-information utilizing educational method in accordance with the preferred embodiment of the present invention.

FIG. 34 is a view illustrative of still another example of Web-page layout involved in the learning-history-information utilizing educational method in accordance with the preferred embodiment of the present invention.

FIG. 35 is a view illustrative of still another example of Web-page layout involved in the learning-history-information utilizing educational method in accordance with the preferred embodiment of the present invention.

FIG. 36 is a view illustrative of still another example of Web-page layout involved in the learning-history-information utilizing educational method in accordance with the preferred embodiment of the present invention.

### DETAILED DESCRIPTION OF THE PREFERRED EMBODIMENTS

A first aspect of the present invention is an educational method of utilizing a learning history information. At least one student's account is provided with at least one subject-related information, which has been classified in a designated field and registered in a data base. At least one teacher's account is provided with at least one student-prepared essay information with an edition-number-related information, which corresponds to the at least one subject-related information. A registration is made of the at least one student-created essay information into the data base, in combination with a teacher-providing evaluation record information and a designated-field-related information.

It is possible that elements constituting the at least one student-prepared essay information are distinguishably registered in the data base.

It is also possible that the at least one student-prepared essay information is registered in an XML format into the data base.

It is also possible that the at least one student-prepared essay information is converted into other format.

It is also possible that the at least one student-prepared essay information is converted into an HTML format according to predetermined XSL data.

It is also possible that at least one editable bulletin board is displayed.

It is also possible that the at least one editable bulletin board enables selection of any one of display and non-display of contents of the at least one editable bulletin board and also re-ordering in accordance with a category classification.

It is also possible that the at least one editable bulletin board has a project entry function of entering a teacher-decided project from the at least one teacher's account, and an access setting function of setting an access to the account.

It is also possible that the at least one editable bulletin board enables a predetermined account to delete data, which have been written by a different account, from the at least one editable bulletin board.

It is also possible that the teacher-providing evaluation record information is distinguishably registered for each item in the data base.

A second aspect of the present invention is an educational system of utilizing a learning history information. The system includes: at least one web-server; at least one application server electrically coupled to the at least one web-server; and at least one data base server electrically coupled to the at least one web-server and the at least one application server. The at least one web-server is accessible to at least one teacher's terminal logged-in at a teacher's account and also to at least one student's terminal logged-in at a student's account. The at least one application server includes: a first function unit of providing at least one student's account with at least one subject-related information, which has been classified in a designated field and registered in the at least one data base server; a second function unit of providing at least one teacher's account with at least one student-prepared essay information with an edition-number-related information, which corresponds to the at least one subject-related information; and a third function unit of making a registration of the at least one student-created essay information into the at least one data base server, in combination with a teacher-providing evaluation record information and a designated-field-related information.

It is possible that elements constituting the at least one student-prepared essay information are distinguishably registered in the at least one data base server.

It is also possible that the at least one student-prepared essay information is registered in an XML format into the at least one data base server.

It is also possible that the at least one application server further includes: a fourth function unit of converting the at least one student-prepared essay information into other format.

It is also possible that the at least one student-prepared essay information is converted into an HTML format according to predetermined XSL data.

It is also possible that the at least one application server further includes: a fifth function unit of displaying at least one editable bulletin board.

It is also possible that the at least one editable bulletin board enables selection of any one of display and non-display of contents of the at least one editable bulletin board and also re-ordering in accordance with a category classification.

It is also possible that the at least one application server further includes: a sixth function unit of entering a teacher-decided project onto the at least one editable bulletin board at the at least one teacher's account; and a seventh function unit of setting an access to the account.

It is also possible that the at least one editable bulletin board enables a predetermined account to delete data, which have been written by a different account, from the at least one editable bulletin board.

It is also possible that the teacher-providing evaluation record information is distinguishably registered for each item in the at least one data base server.

The following embodiments are typical examples for practicing the foregoing aspects of the present invention. Although the subject matters of the present invention have been described in details, the following additional descriptions in one or more typical preferred embodiments or examples will be made with reference to the drawings for making it easy to understand the typical modes for practicing the foregoing aspects of the present invention.

### PREFERRED EMBODIMENT

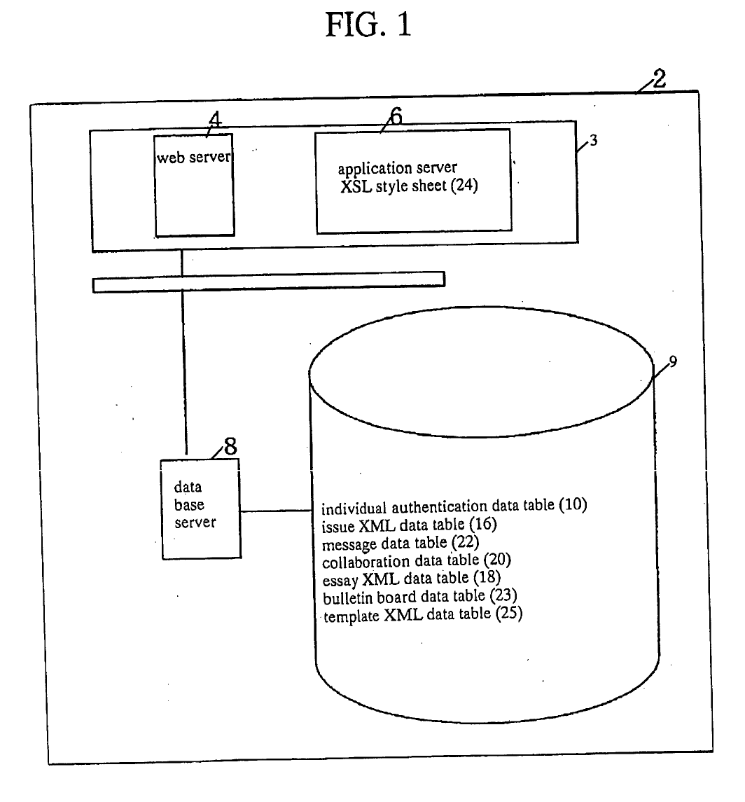

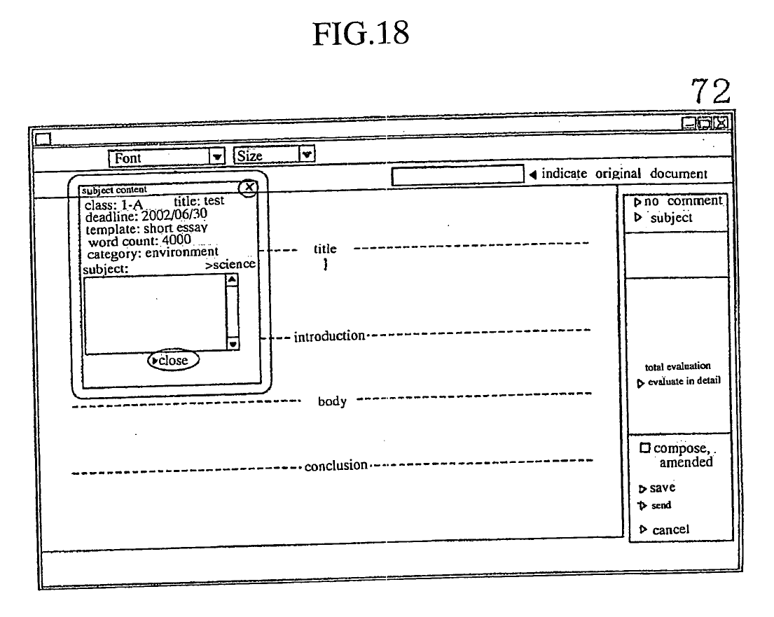

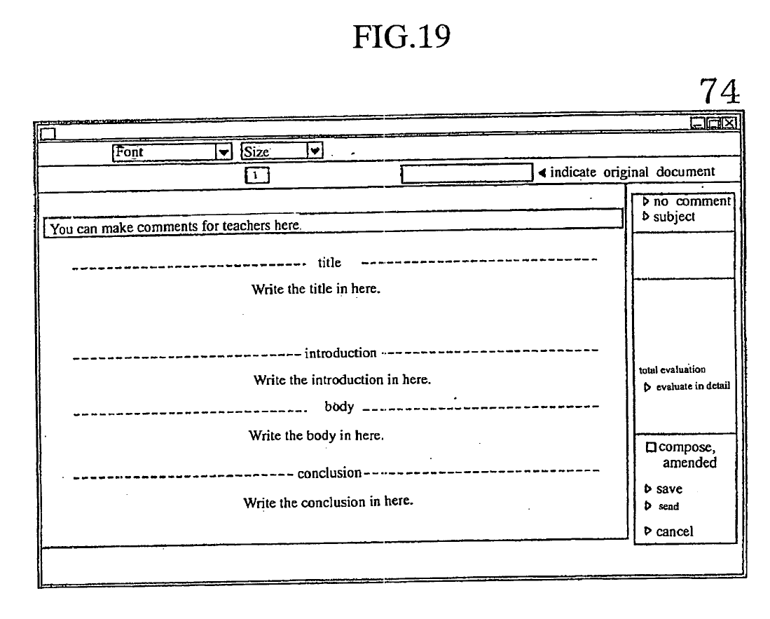

The preferred embodiment according to the present invention will be described in detail with reference to the drawings of FIGS. 1 through 31. FIG. 1 is a block diagram illustrative of a configuration of a learning-history-information utilizing educational system in accordance with the preferred embodiment of the present invention. A learning-history-information utilizing educational system 2 includes a control unit 3 and a data base server 8 connected to a data base 9. The control unit 3 further includes a Web-server 4 and an application server 6. The data base server 8 is also connected to the control unit 3.

The application server 6 is provided for preparing a Web-page showing data and XML data. The Web-server 4 is provided for displaying a Web-page which has been prepared by the application server 6 in accordance with a request for data which had been transmitted through a communication network such as the Internet.

The data base 9 includes a plurality of the following data tables. The data base 9 includes an individual authentication data table 10, to which an ID and a password are introduced for allowing an access to the data base 9. It is also desirable to optionally provide an additional RADIUS server for making the individual authentication.

The application server 6 has a bulletin board function, an inbox function, a massage function, a chat function, a data conversion function and an XSL (extensible Style Language) style sheet 24.

The bulletin board function is to display a bulletin board and also register contents written on the bulletin board onto a bulletin board data table 23.

The inbox function is to register registered issue informations onto an subject XML data table 16 as well as display issues and an account of a teacher, who prepared the issues, onto an inbox page of a student as a recipient.

The message function is substantially the same as an e-mail function. The message function is to designate a destination account and transmit a text information to the designated destination, wherein data are registered on a message data table 22.

The chat function allows a read-time-base conversation with characters written on pages among plural users who have had accesses to the communication network. The chat function display in read-time-base a text entered by an account having the access on all monitors connected in read-time. Chat data are registered on a collaboration data table 20.

The data conversion function converts data of an evaluated essay in all essays registered on an essay XML data table 18 into other data form, based on XSL data registered on the XSL style sheet 24.

The XSL style sheet 24 is a style sheet for conversion of the XML data to HTML data. The XSL style sheet 24 comprises a data base of a language XSL defining the expression way of XML data. The XML data are converted to HTML data by utilizing the XSL data.

The data server 8 is connected to the individual authentication data table 10, the subject XML data table 16, the essay XML data table 18, the collaboration data table 20, the message data table 22, the bulletin board data table 23, the XSL style sheet 24, and a template XML data table 25. Those tables may be included in the data base 9.

The individual authentication data table 10 has previously stored password informations to ID. The individual authentication data table 10 authenticates an individual access by confirming whether or not an account who has an access to the Web-server 4 is an authenticated account. For example, it is verified whether or not a transmitted combination of an ID and a password is identical with the registered combination of an ID and a password on the individual authentication data table 10.

The subject XML data table 16 comprises registered data, divided depending upon classification, of issues to be registered at an Assignment-page 68.

The essay XML data table 18 comprises registered data including an essay prepared by a student and a teacher's correction.

The collaboration data table 20 comprises chat data in collaboration, entry comment data and fair copy data.

The chat data include an entry text data and an account information of a person who has entered entry text data.

The entry comment data include the comment information entered in collaboration, a display/non-display information, and a classification information.

The fair copy data are to be registered upon pushing a fair copy switch, and shows a result of a project.

The message table 22 comprises data including a new arrival InBox information transmitted from an account of student and a new arrival message information of a newly received e-mail.

The bulletin board data table 23 includes a teacher's communication bulletin board and a student's communication bulletin board as well as entry forms for those bulletin boards.

The template XML data table 25 comprises data for preparing a template and prepared template data.

The learning-history-information utilizing educational system 2 may comprise the above-described typical example of the configuration, even the configuration should not be limited to the above-described configuration.

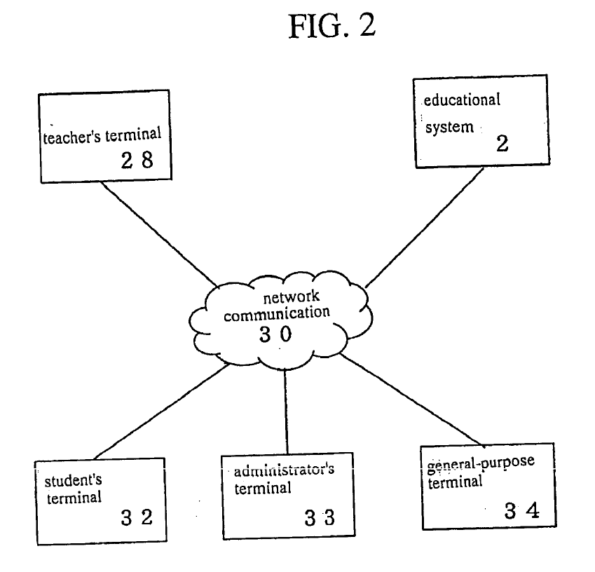

FIG. 2 is a diagram illustrative of a typical example of a configuration of a network including the learning-history-information utilizing educational system and other terminals connected each other through a communication network in accordance with the preferred embodiment of the present invention.

The learning-history-information utilizing educational system 2 may be connected to at least one teacher's terminal 28 through any available communication network 30 such as the Internet. The learning-history-information utilizing educational system 2 may also be connected to at least one student's terminal 32 through the communication network 30. The learning-history-information utilizing educational system 2 may also be connected to at least one administrator's terminal 33 through the communication network 30. The learning-history-information utilizing educational system 2 may also be connected to at least one general-purpose terminal 34 through the communication network 30.

Each of the teacher's terminal 28, the student's terminal 32, the administrator's terminal 33, and the general-purpose terminal 34 may be realized by any available terminals which are accessible to the communication network 30 and are capable of executing any available Web-browser browsing HTML. Typical examples of the available terminals may include, but not limited to, desk top type computers, note-type computers, portable-type computers and advanced mobile-phone terminals.

The number of each of the teacher's terminal 28, the student's terminal 32, the administrator's terminal 33, and the general-purpose terminal 34 is optional.

The teacher's terminal 28 is provided for the use by a person having a teacher's account. The student's terminal 32 is provided for the use by a person having a student's account. The administrator's terminal 33 is provided for the use by a person having a administrator's account. The general-purpose terminal 34 provided for the use by a person free of any account.

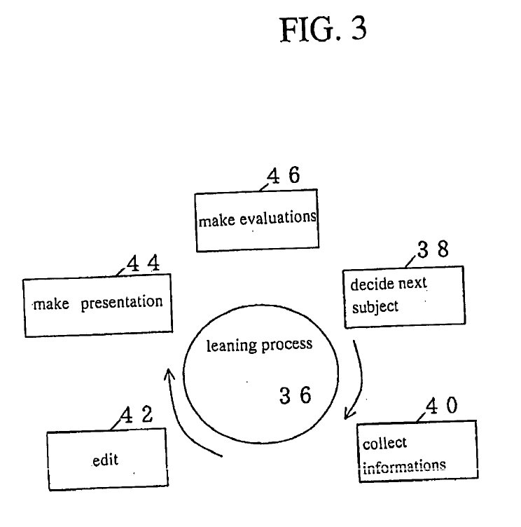

FIG. 3 is a diagram illustrative of a conceptional leaning process according to the learning-history-information utilizing educational method in accordance with the preferred embodiment of the present invention. A leaning process 36 may include the following five processes. A first process 38 is that a teacher decides and provides a learning subject matter to a student. A second process 40 is that the student collects informations related to the subject matter. A third process 42 is that the student derives a conclusion of the subject matter from the collected informations, and edits an essay related to a logical process to the conclusion. In the editing process, the student has a discussion about the editing essay with the teacher. The discussion between the student and the teacher may be made through any available ways, typical examples of which may include, but not limited to, exchange of messages, chats, and bulletin boards. A fourth process 44 is that the student makes a presentation based on the edited essay to other students. A fifth process 46 is that the other students and the teacher make evaluations on the presentation as made. The evaluations may include numerical evaluations such as five stage evaluations as a digital evaluation method, and word-depending evaluations as an analog evaluation method. After the fifth process 46, the first process 38 will be made again so that the next subject matter be decided by the teacher in consideration of the result of the evaluations made in the fifth process 46. The above-described first to fifth processes are cyclically repeated as shown in FIG. 3.

The cyclical repeats of the above-described first to fifth processes 38, 40, 42, 44 and 46 may improve a plurality of abilities of the student. In the second process 40, the student collects the informations related to the subject matter decided in the first process 38, whereby a research ability 48 of the student may be improved. In the third process 42, the student edits the collected informations and writes an essay with reference to the edited informations, whereby a thinking ability 52 of the student may be improved. Further, the discussion with the other students and the teacher may improve a conversation ability 50 of the student, for example, an ability of explaining and persuading other people of his or her opinion and another ability of hearing and interpreting other people's opinion. In the fifth process 44, the student makes the presentation based on the essay, whereby a presentation ability 54 of the student may be improved. Comprehensive improvements of the research ability 48, the conversation ability 50, the thinking ability 52 and the presentation ability 54 may improve a creativity 56 of the student.

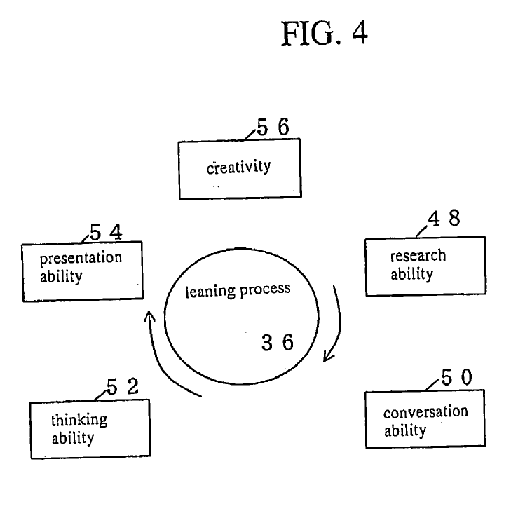

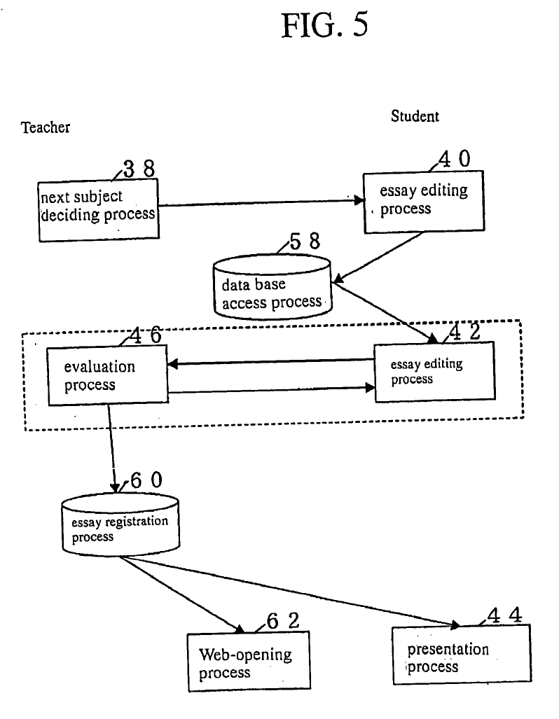

FIG. 5 is a flow diagram illustrative of the conceptional leaning process shown in FIGS. 3 and 4, where the processes are classified into the teacher's processes made by the teacher and the student's processes made by the student. The teacher's processes include the evaluation process 46 making an evaluation on the essay prepared by the student, an essay registration process 60 for registering the evaluated student's essay, and a Web-opening process 62 for opening the essay on the Web. The student's processes include the information collection process 40 for collecting the informations related to the subject matter given by the teacher, a data base access process 58 for making an access to a variety of data bases, an essay editing process 42 for editing the essay, and a presentation process 44 for making the presentation.

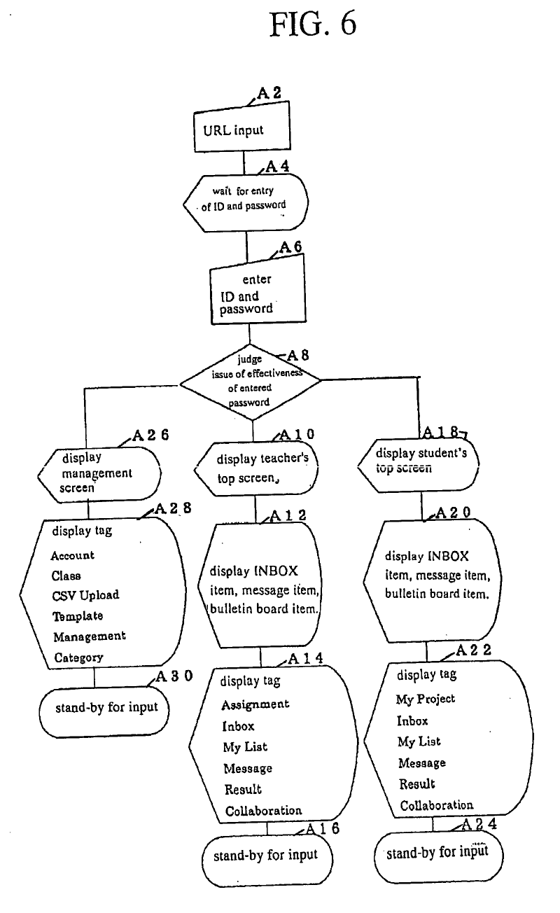

The learning-history-information utilizing educational method of the referred embodiment of the present invention will be described with reference to FIGS. 6 through 30.

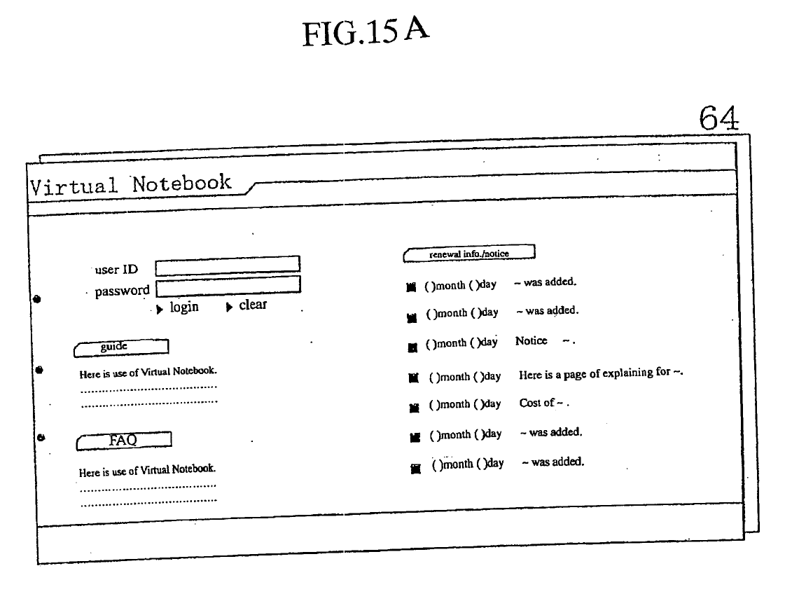

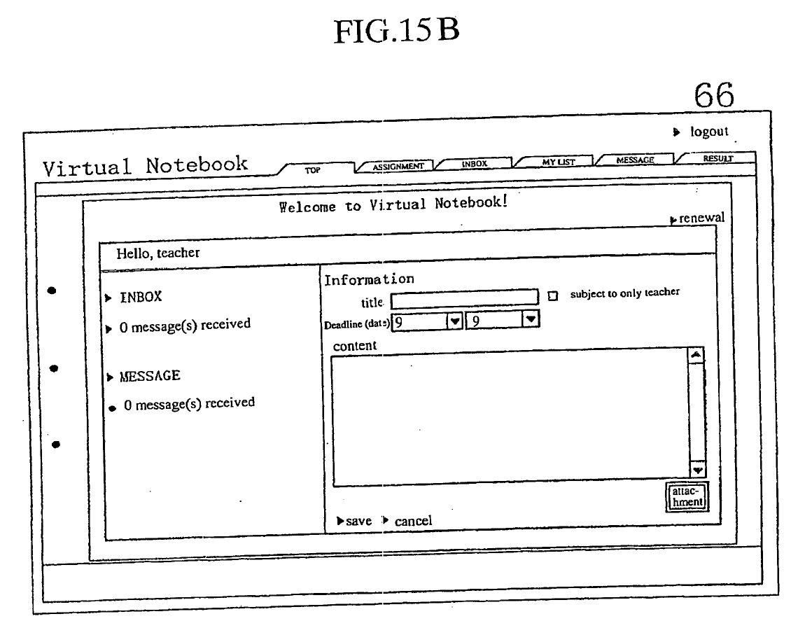

FIG. 6 is a flow chart illustrative of sequential steps involved in the learning-history-information utilizing educational method, from a login page display step to a top page display step. FIG. 15A is a view illustrative of a login page layout involved in the learning-history-information utilizing educational method. FIG. 15B is a view illustrative of a top page layout involved in the learning-history-information utilizing educational method.

In a step A2, a uniform resource locator (URL) of this learning-history-information utilizing educational system 2 is designated by a Web-browser of any one of the teacher's terminal 26 and the student's terminal.

In a step A4, the learning-history-information utilizing educational system 2 transmits data of a login page 64 shown in FIG. 115A to the Web-browser having designated this URL of the learning-history-information utilizing educational system 2, before the learning-history-information utilizing educational system 2 is placed in a stand-by state of waiting for the entry of an ID and a password of a person who requests for an access to this learning-history-information utilizing educational system 2.

In a step A6, an ID and a password are entered and transmitted to the learning-history-information utilizing educational system 2.

In a step A8, the Web-server 4 of the learning-history-information utilizing educational system 2 retrieves a registered ID from the individual authentication data table 10 and judges an issue of effectiveness of the entered password. If the learning-history-information utilizing educational system 2 judges that the entered password is ineffective or invalid, then the learning-history-information utilizing educational system 2 displays a notice to the effect that the entered password is ineffective or invalid, and transmits a signal to the effect that the entered password is ineffective or invalid to the terminal.

If the learning-history-information utilizing educational system 2 judges that the entered password is effective or invalid, then the learning-history-information utilizing educational system 2 makes an access to the individual authentication data table 10 for judging whether this entered effective ID is of the student's account, the teacher's account or the administrator's account.

In a step A10, if the ID is of the teacher's account, then the learning-history-information utilizing educational system 2 transmits data of a teacher's TOP page 66 shown in FIG. 15B to the teacher's terminal 26, to enable the teacher's terminal 26 to display the teacher's TOP page 66.

In a step A12, the teacher's TOP page 66 may include an INBOX index, a MESSAGE index and a bulletin board index. The INBOX index displays the number of cases of essay informations which have been transmitted from the student account to the teacher's account for teacher's correction thereof. The MESSAGE index displays the number of cases of student's e-mails which have been transmitted from the student account to the teacher's account for enabling the teacher to review MESSAGE informations of the e-mail. The bulletin board index provides a teacher's communication bulletin board for communications between teachers, and a teacher's-student's communication bulletin board for communications between teacher and student, as well as entry forms for those bulletin boards.

In a step A14, the teacher's TOP page 66 displays a plurality of tags which may include, an ASSIGNMENT tag providing a linkage to a subject-creating page, an INBOX tag providing a linkage to a student's essay correction page, a MY LIST tag providing a linkage to a list of a past essay history retrieval page, a MESSAGE tag providing a linkage to an e-mail transmission/receiving page, a RESULT tag providing a linkage to a page displaying a result of evaluation on the essay, and a COLLABORATION tag providing a linkage to a page including a chat for project and an editable bulletin board.

In a step A16, the system is placed in a stand-by state for entry.

In a step A18, if the ID is of the student's account, then the student's TOP page information is transmitted to the student's terminal 32 for displaying the same.

In a step A20, the student's TOP page comprises an INBOX item, a MESSAGE item and a bulletin board item. The INBOX item displays a new arrival subject information newly presented by teacher for enabling the student to make a new essay, as well as the number of cases of the essay informations, for which the teacher's corrections have been completed. The MESSAGE item displays the number of cases of MESSAGE informations of e-mails transmitted to the student's account. The bulletin board item provides a teacher's-student's commination bulletin board and an entry format for this bulletin board.

In a step A22, the student's TOP page displays a plurality of tags which may include, an ASSIGNMENT tag providing a linkage to the subject-creating page, an INBOX tag providing a linkage to the student's essay correction page, a MY LIST tag providing a linkage to the list of the past essay history retrieval page, a MESSAGE tag providing a linkage to the e-mail transmission/receiving page, a RESULT tag providing a linkage to the page displaying the result of evaluation on the essay, and a COLLABORATION tag providing a linkage to the page including the chat for project and the editable bulletin board, as well as a MY PROJECT tag providing a linkage to a page for record of essays for researched contents for free subjects which have been presented by the student.

In a step A24, the system is then placed in a stand-by state for entry.

In a step A26, if the ID is of the administrator's account, then the administrator's page information is transmitted to the administrator's terminal for displaying the same.

In a step A28, the administrator's page displays a plurality of tags which include an ACCOUNT tag, a CLASS tag, a CSV UPLOAD tag, a TEMPLATE tag, a MANAGEMENT tag, and a CATEGORY tag.

In a step A30, the system is then placed in a stand-by state for entry.

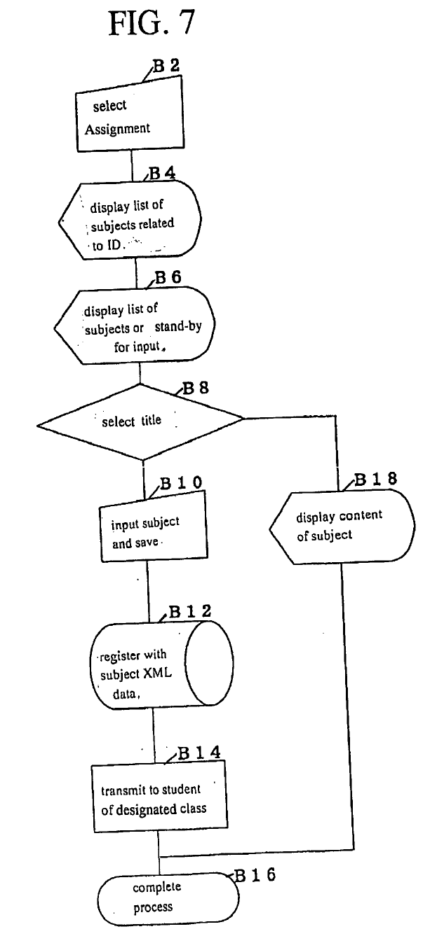

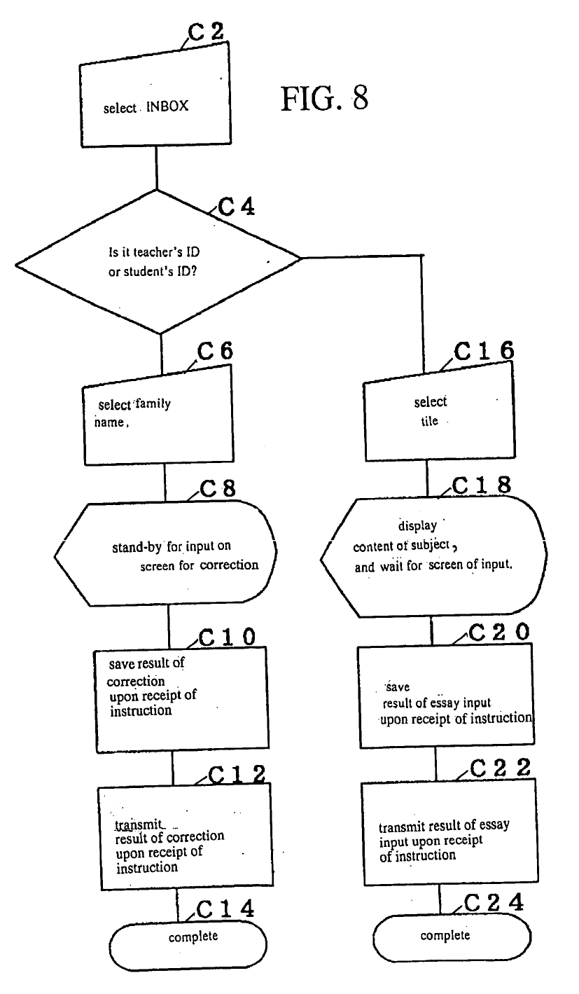

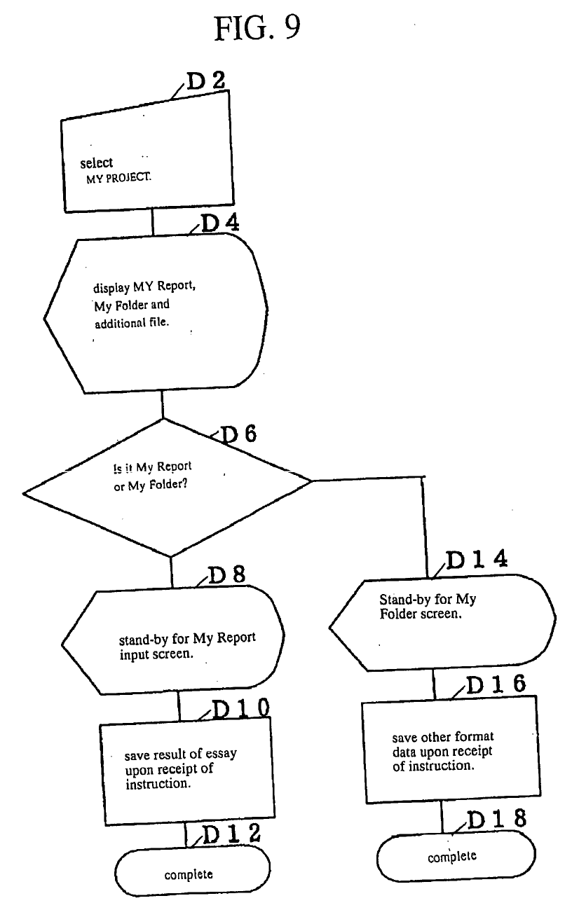

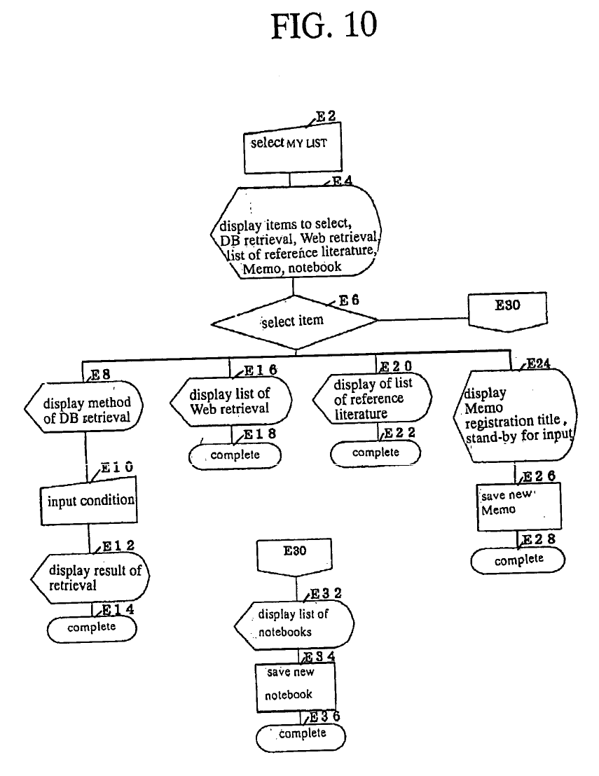

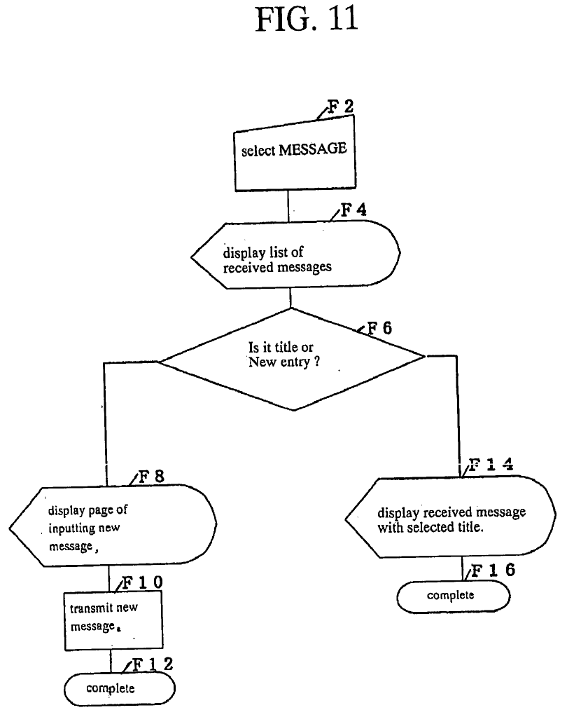

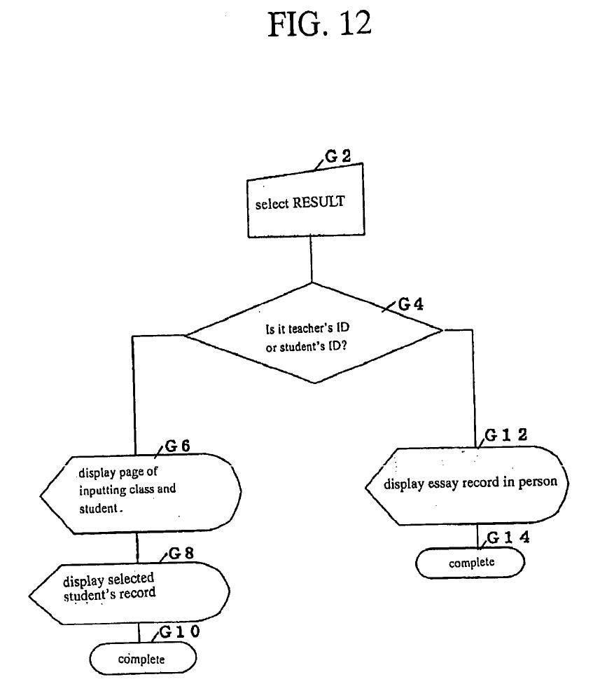

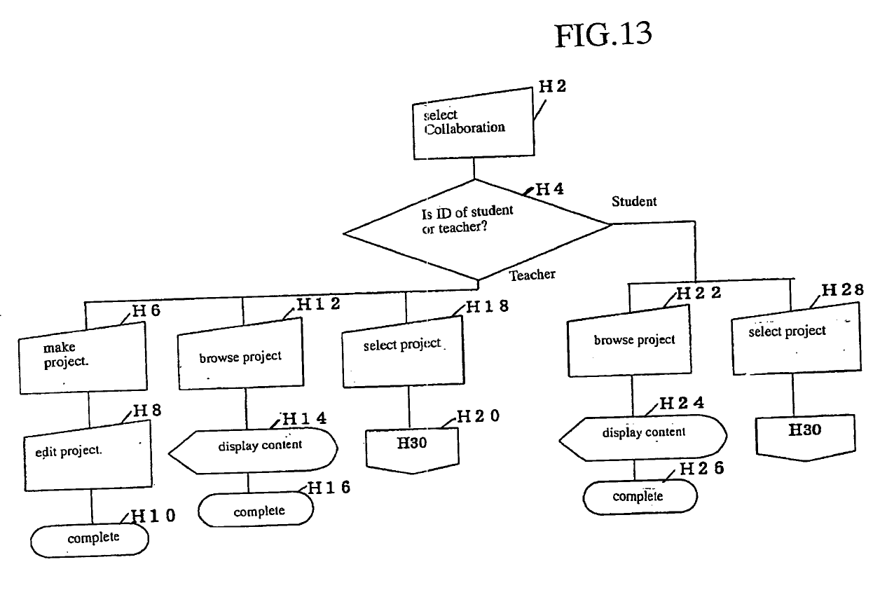

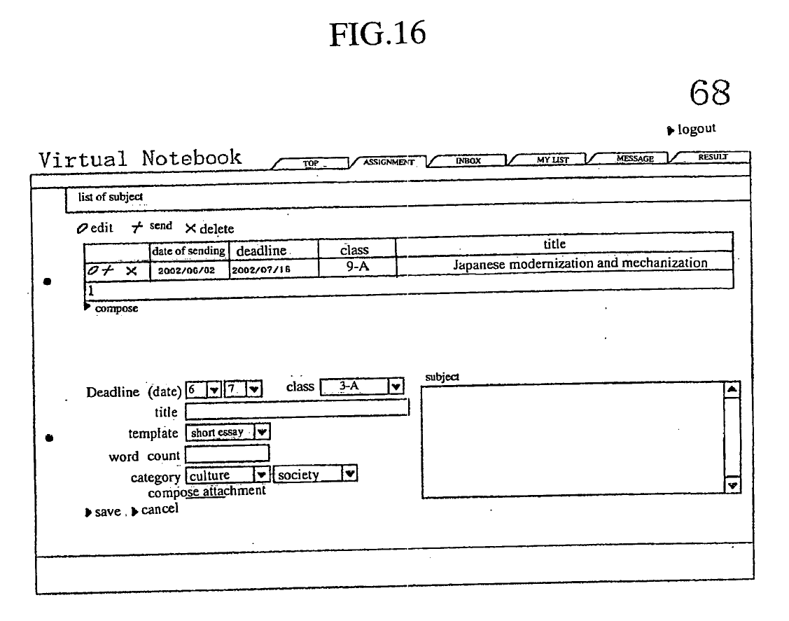

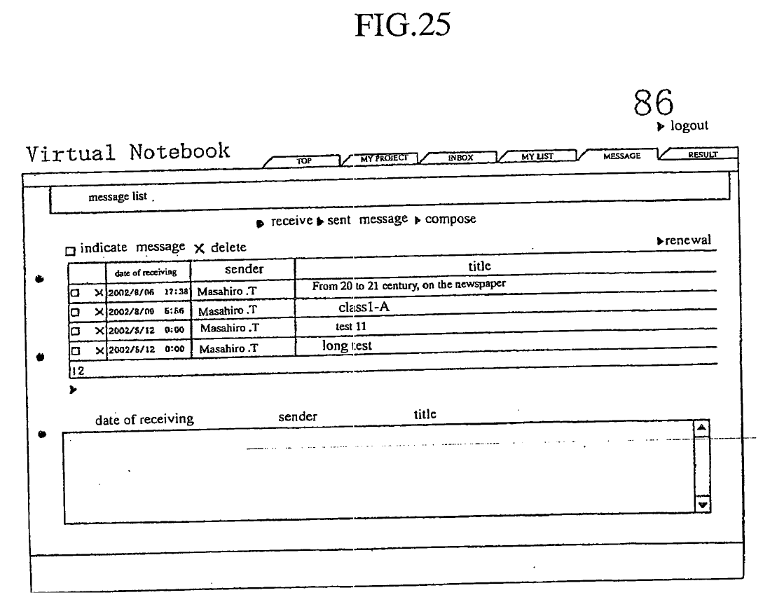

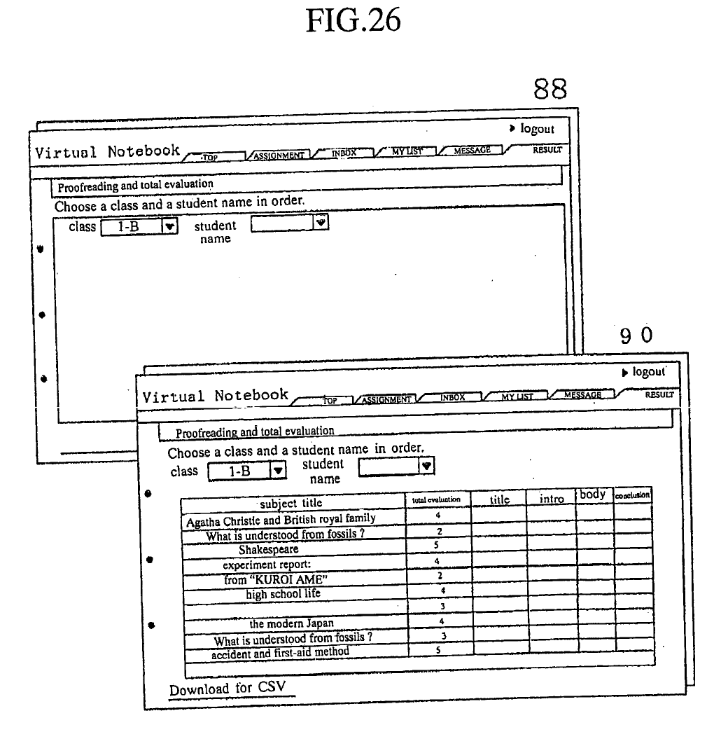

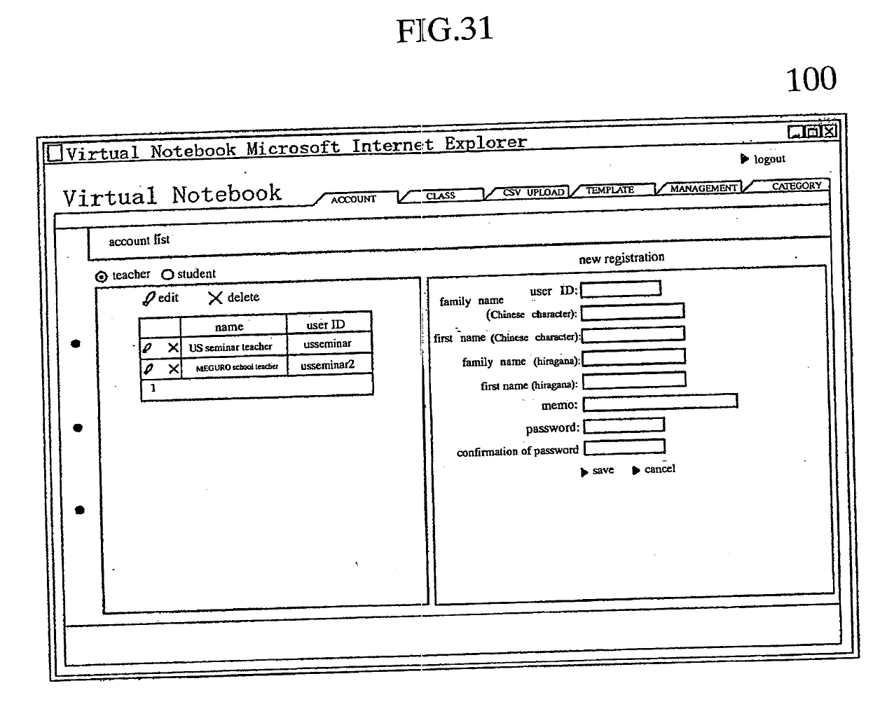

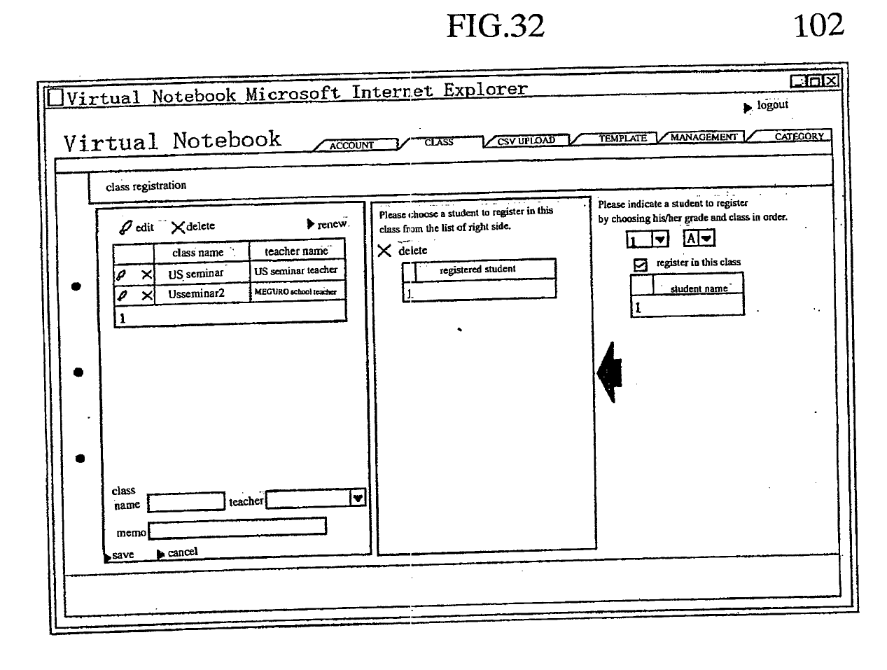

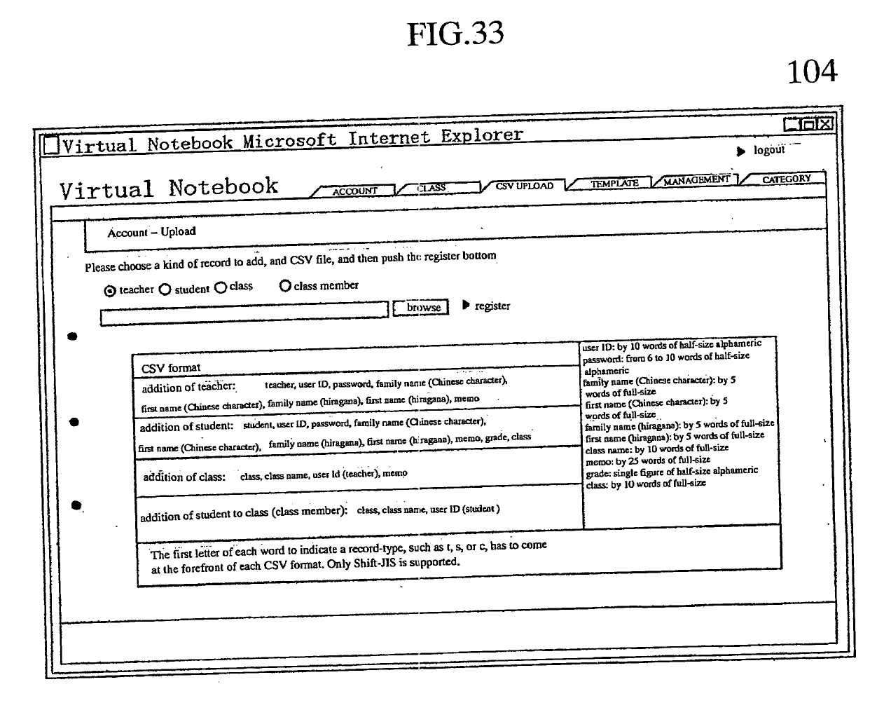

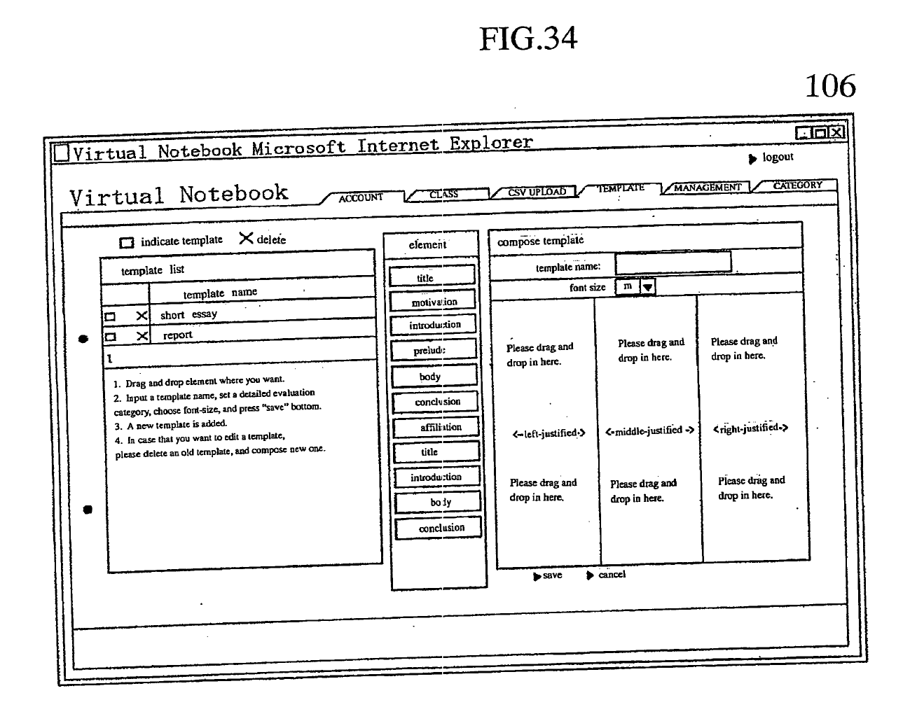

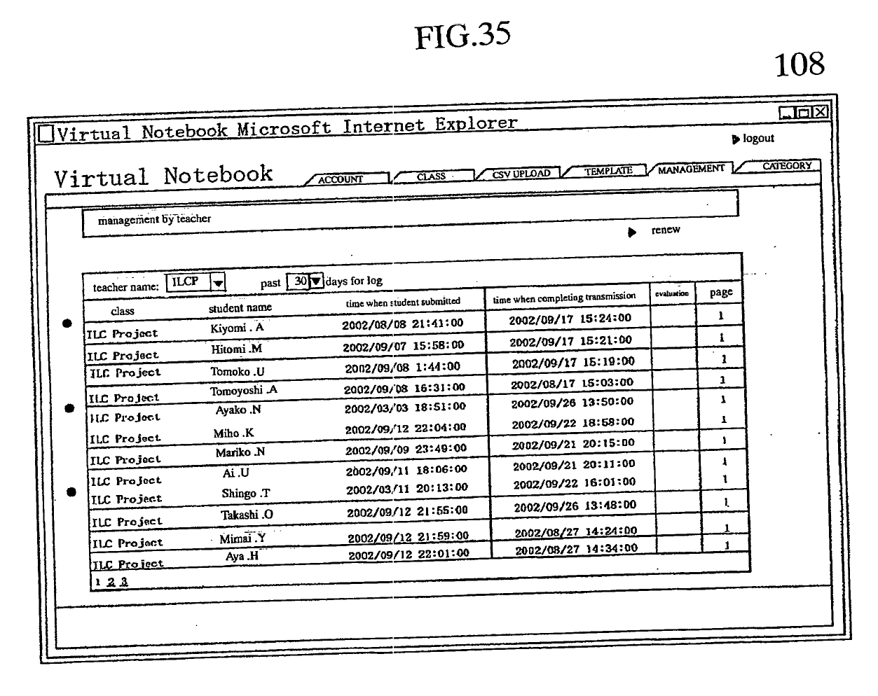

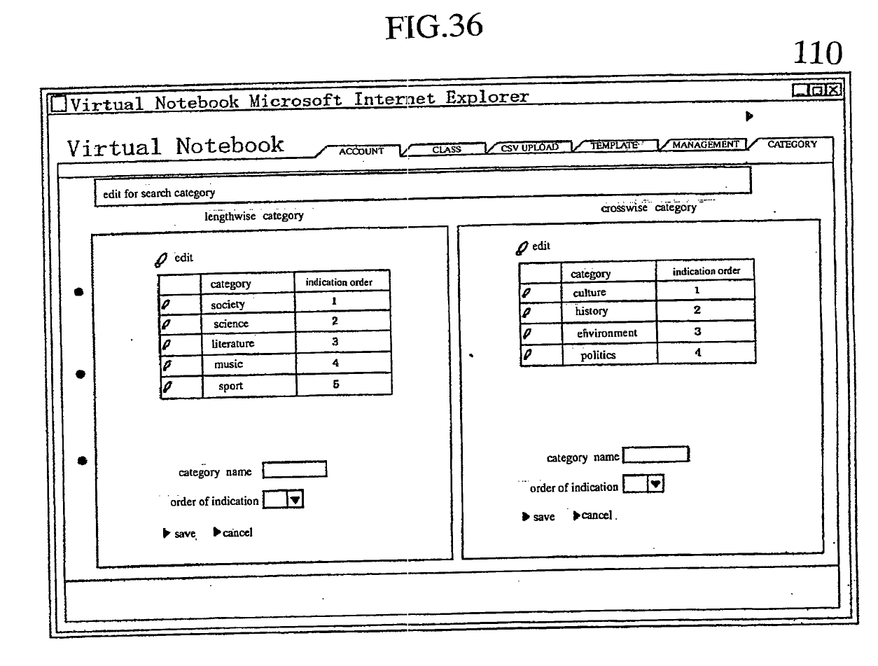

The following descriptions will focus on respective pages corresponding to the above-described respective tags shown in the above-described steps A14, A22 and A28. The ASSIGNMENT page 68 is shown in FIGS. 7 and 16. The INBOX page is shown in FIGS. 8, 17-19. The MY PROJECT page is shown in FIGS. 9, 20 and 21. The MY LIST page is shown in FIGS. 10, 22-24. The MESSAGE page is shown in FIGS. 11 and 25. The RESULT page is shown in FIGS. 12 and 26. The COLLABORATION page is shown in FIGS. 13, 27-30. The ACCOUNT tag is shown in FIG. 31. The CLASS tag is shown in FIG. 32. The CSV UPLOAD tag is shown in FIG. 33. The TEMPLTE tag is shown in FIG. 34. The MANAGEMENT tag is shown in FIG. 35. The CATEGORY tag is shown in FIG. 36.

The descriptions will be made with referecne to FIG. 7. In a step B2, the ASSIGNMENT page 68 is displayed upon selecting the ASSIGNMENT tag in the step A14.

In steps B4 and B6, the ASSIGNMENT page 68 displays a list of the subject items presented by the teacher with the selected ID, wherein the subjects are presently within the due date, as well as displays the subject entry format.

In a step B8, the list of the subject items displays, for each subject, the day of transmitting the subject to the student, the due date of submitting the response to the subject, the name of a selected class, to which the subject is selectively presented, and the title of the subject. Detailed contents thereof are displayed upon selecting the title.

The subject entry format allows entries of the due date, the subject presented class name, the subject tile, the template of creating the subject, a maximum number of words of the essay, the category and the entry forms for entry of the subject contents. This category further includes a vertical category and a horizontal category. The dependency of each category is further classified into four subordinate categories in view of the vertical and horizontal categories. For example, the heliocentric theory may be categorized to “science” in the vertical category and “history” in the horizontal category. In view that the heliocentric theory has a larger meaning in Christian's historical views than in the scientific discovery, then the category is classified so closer to the “history” than the “science”. The four subordinate categories may, for example, be presented by colors such as “red”, “yellow”, “green” and “blue”.

The subject creating template provides templates for “short essay” and “dairy” and allows selection of the template prepared by the management page 106. The “short essay” template defines the title, the introductory remarks, the body, the conclusion in the XML format. The “dairy” template defines the title, the day and the body.

In steps B10 and B12, if the signal for selecting the title in the subject item list is not transmitted from the teacher's account, while data are entered into the subject entry form and a signal for selecting a save switch is transmitted, then the new subject data are registered on the subject XML data table 16.

In a step B14, the new subject information is delivered to the student's accounts belonging to the designated class. The ASSIGNMENT page has been thus completed.

In a step B18, if the signal for selecting the title in the subject item list has been transmitted from the teacher's account, then the contents of the subject corresponding to the selected title has been displayed on the ASSIGNMENT page 68.

This ASSIGNMENT page 68 corresponds to the process 38 that a teacher decides and provides a learning subject matter to a student, wherein the subject is categorized by the teacher.

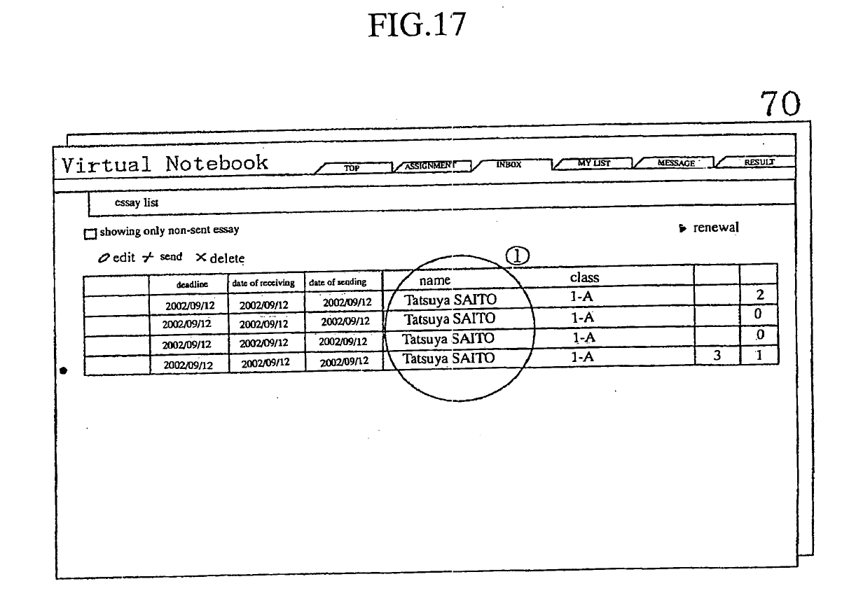

The description related to the INBOX page shown in FIG. 17 will be described with reference to FIG. 8.

In a step C2, if the INBOX tag is selected in the above-described steps A14 and A22, then the INBOX tag is displayed.

In a step C4, if the account is the teacher's account, then a teacher's essay information list 70 is displayed which presents the essay informations transmitted from the student's account to the teacher's account.

The teacher's essay information list 70 presents, for each essay, the due date of submitting the essay, the date of receipt of the essay information from the student's account, the date of transmitting the corrected essay information to the student's account, the name of the student's account, the class name of the student's account, the evaluation points of the evaluated essay, and the number of submissions of the essays to the teacher's account.

In a step C6, a signal for selecting the name of the student's account in the teacher's essay information list 70 is transmitted to the present system.

In a step C8, an information of a correction page 74 is transmitted to the teacher's account.

In a step C10, if a save signal for saving the correction information or the evaluation information from the teacher's account is transmitted from the teacher's account to the present system, then the present system saves the correction information or the evaluation information into the essay XML data table 18.

In a step C12, the correction information or the evaluation information is also transmitted to the student's account who had prepared the present essay.

In a step C14, if the account is the teacher's account, then the process has been completed.

The evaluations made to the essay may include, but not limited to, an evaluation on the title in view of correctness, another evaluation on the contents of the introductory remarks, still another evaluation on the body of the essay, yet another evaluation on the conclusion of the essay, a comprehensive evaluation depending on numerical expressions, an evaluation on the issue of whether the evaluating essay is the category of excellence, as well as a subject-matching evaluation on the issue of whether the essay matches to the subject, a further evaluation on the constitution of the essay, still further evaluation on the expression of the essay, and an additional advise to the essay. Those evaluation items may have previously been prepared in the templates. It is also possible to newly and optionally make text evaluation items and numerical evaluation items for the sub-titles of the essay, wherein the constitutional definitions of the templates of the management page accord to the subject format and the evaluation items. The evaluation items may be added to the teacher's essay information list 70 and registered on the essay XML data table 18. After the essay was evaluated by the teacher, then the editing process has been completed to register the essay.

In the step C4, if the account is the student's account, then there are displayed the new subject information transmitted from the teacher's account to the student's account, the essay information with the correction and evaluation thereof. Further, a student's essay information list is also displayed.

The student's essay information list is different from the teacher's essay information list 70 in view of displaying the title instead of the student's name.

In a step C16, a signal for selecting the title in the student's essay information list is transmitted to the present system.

In a step C18, a subject content display window and an information of the essay creating page 72 are transmitted to the student's account.

In a step C20, if a save signal of saving the essay creating information or a comment 74 to the teacher is transmitted from the student's account to the present system, then the present system saves the essay creating information or the comment 74 to the teacher on the essay XML data table 18.

In a step C22, the essay creating information or the comment 74 to the teacher is also transmitted to the teacher's account who corrects the essay.

In a step C24, if the account is the teacher's account, then the processes have been completed.

The INBOX page 70 is shown in FIG. 17. Repeating the edition of the essay through the teacher's evaluation 46 and the registration of the essay 60 shown in FIG. 5 may improve the quality of the essay and also improve the research ability, the conversation ability and the thinking ability of the student.

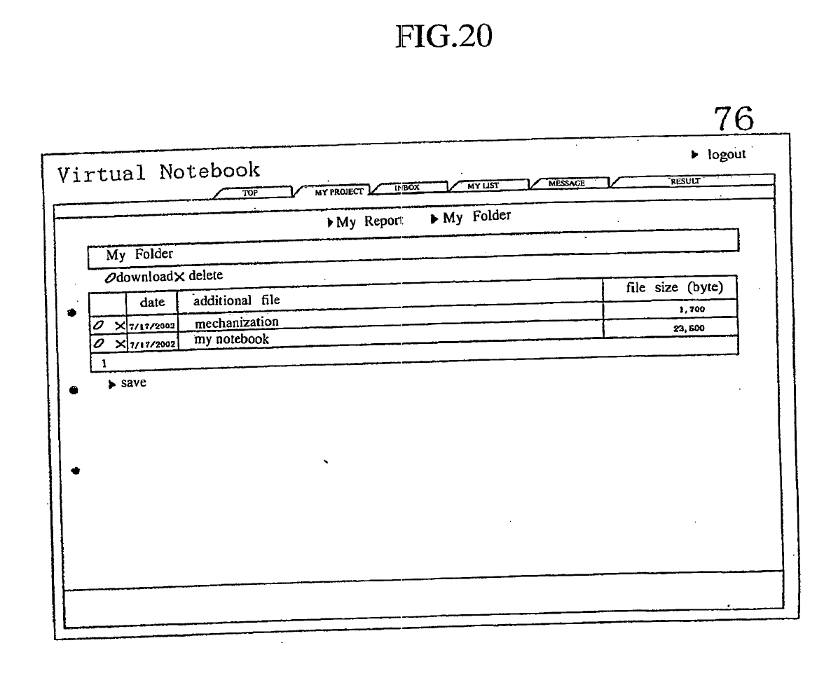

With reference to FIG. 9, in a step D2, the MY PROJECT page 76 is shown in FIG. 20. The MY PROJECT page 76 is displayed in the step A22 upon selecting the MY PROJECT tag. The MY PROJECT page 76 is displayed only at the student's account.

In a step D4, the MY PROJECT page 76 displays a MY Report tag and a My Folder tag.

In a step D6, a signal for selecting the My Report tag is transmitted to the present system.

In a step D8, the My Report window is transmitted to the student's account.

In steps D8 and D10, the student give the My Report window the free subject information, wherein the free subject information is registered on the subject XML data table 16. The essay information is also transmitted to the present system and then registered on the essay XML data table 18. The My Report process has been completed.

In a step D6, a signal for selecting the My Folder tag is transmitted to the present system.

In a step D14, the My Folder window 76 is transmitted to the student's account.

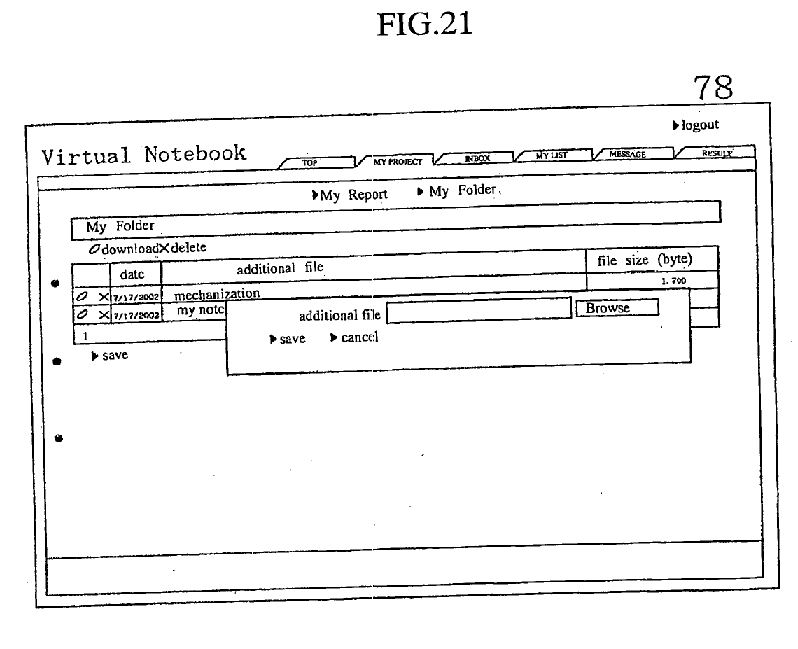

In a step D16, a selecting signal for selecting a save tag for the My Folder window 76 is transmitted to the present system. A display signal of a save window 78 shown in FIG. 21 is transmitted to the student's account, whereby a save form of other format file is displayed. The other format file information is entered into this form, thereby saving the same in the present system.

The MY PROJECT page 76 shown in FIG. 20 corresponds to the edition process 42 shown in FIG. 5, thereby to improve the student's independency.

The descriptions will be made with reference to FIG. 10.

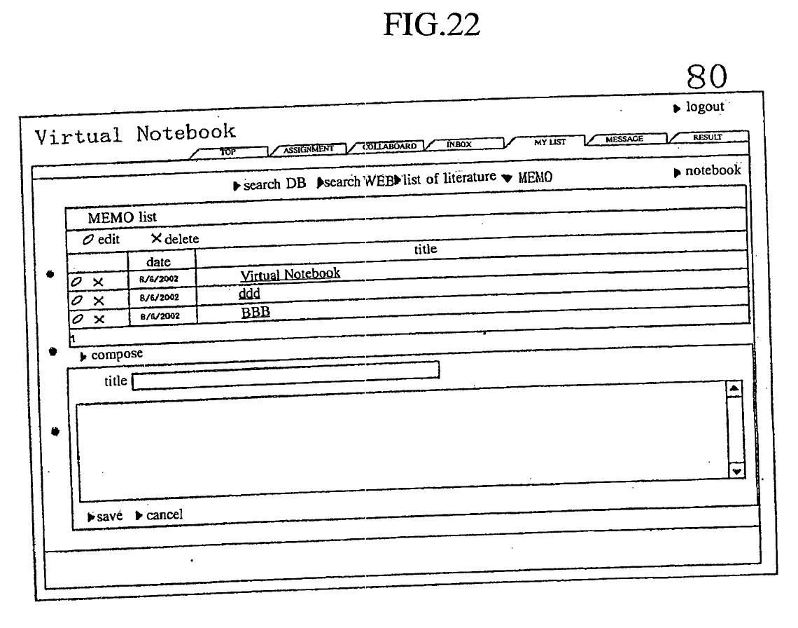

In a step E2, a MY LIST page 80 is shown in FIG. 22 and is displayed upon selecting the MY LIST tag in the steps A14 and A22. This MY LIST page 80 may be displayed at either one of the teacher's account and the student's account.

In a step E4, the MY LIST page 80 displays, as selective items, a DB-retrieval tag, a WEB-retrieval tag, a reference literature list tag, a MEMO-tag, and a note-tag.

In a step E8, a signal for selecting the DB-retrieval tag is transmitted to the present system, then a DB-retrieval page 82 is displayed.

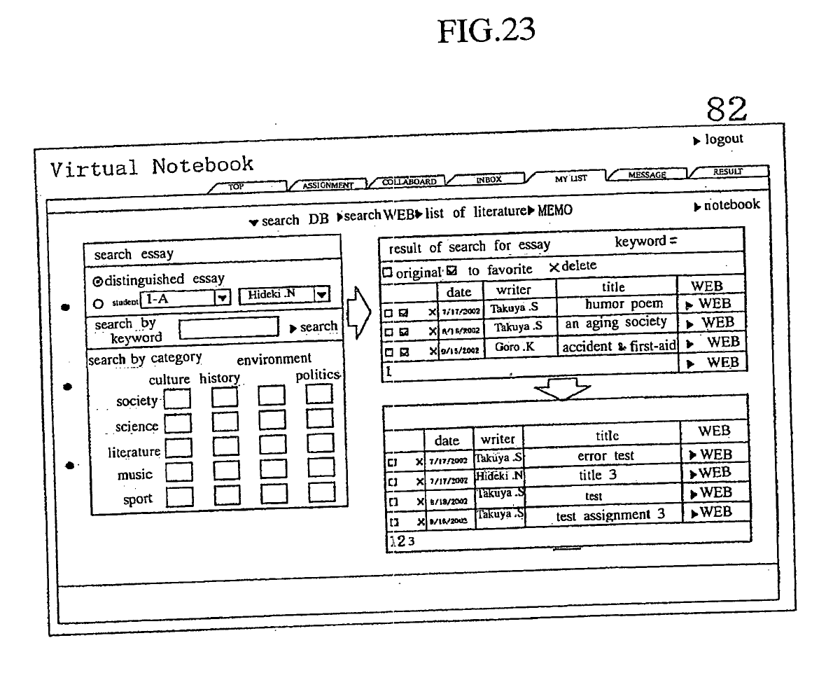

In a step E10, the DB-retrieval page 82 is shown in FIG. 23 and allows a retrieval to essay informations as registered under optional conditions. Typical examples of the retrieval conditions may include, but not limited to, retrieving the essay with reference to the excellency in the evaluation in the INBOX, retrieving the essay with reference to the student's name, retrieving the essay with reference to the key words, and retrieving the essay with reference to the category. The classification of this category may be made by using the above-described four colors “red”, “yellow”, “green” and “blue” for the four-leveled dependencies on the vertical category and the horizontal category designated on the ASSIGNMENT page 68.

In a step E12, a result is displayed which includes the date, the writer's name and the title of the essay. It is also possible to bookmark the essay during the retrieval process.

In a step E16, a signal for selecting the WEB-retrieval is transmitted to the present system, and then the WEB-retrieval page is displayed. The WEB-retrieval page is a page of retrieving, depending on the key words, throughout the WEB-page, on which URLs researched by the WEB-browser.

In a step E20, a selecting signal for selecting the reference literature list is transmitted to the present system, then the reference literature list page is displayed. The reference literature list allows individual to register the searched literature articles. Retrieval may be available to an information from the reference literature list.

In a step E24, a signal for selecting the MEMO is transmitted to the present system, and then a MEMO-page 80 is displayed. The MEMO-page 80 is shown in FIG. 22. The MEMO-page 80 allows registrations of title and registration date as well as the texts. These informations are registered on the individual authentication data.

In a step E26, a news MEMO information is registered upon selecting the save signal.

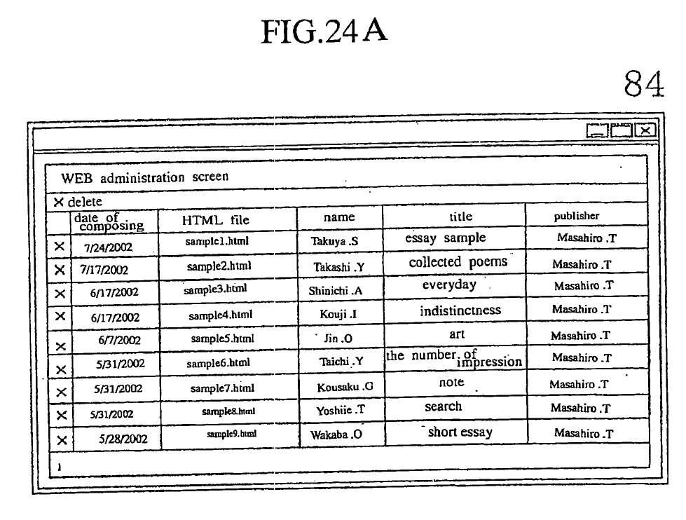

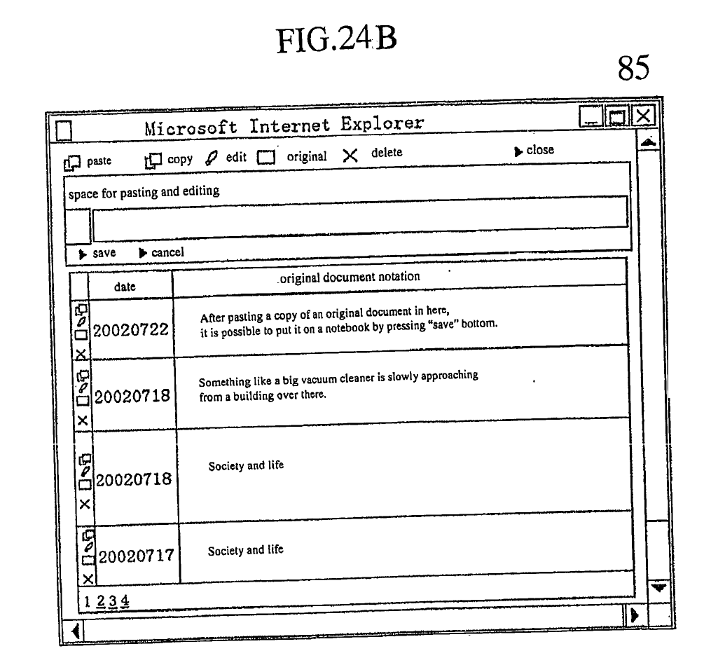

In a step E32, a signal for selecting the notebook is transmitted to the present system, then a notebook page 85 is displayed. The notebook page 85 is shown in FIG. 24B. A notebook list is then displayed.

In a step E34, a save switch is selected, to register the new notebook data onto the individual authentication data table 10. The notebook may be used for temporary store the contents.

The notebook page 85 may register the original texts from the my list or the texts of the Web-site by copying a selected part of the Web-site page and attach the copy on an optional column of the notebook page 85, wherein a link information is also copied and attached in addition to the text information of the selected texts, the image informations. Pushing the save switch makes registration of the information and in place clear the past information on the edited column. Pushing the cancel switch makes no registration and makes clear the information.

It is also possible to register the text prepared myself. Direct entry of an intended information is made into the editing column by typing. Pushing the save switch to register the entered information on the notebook, instead of making the editing column clear. Pushing the cancel switch makes no registration and makes clear the information.

It is also possible to edit the text in the notebook list. Pushing an editing icon of the notebook list, whereby the selected text appears on the editing column for allowing an optional edition in the editing column. After completing the edition, then pushing the save switch overwrites the edited text. Pushing the cancel switch makes no registration and makes clear the information.

If a part of the informations is registered on the notebook, then a linkage is provided to the whole texts, whereby the necessary part of the information and the linkage information of the whole information are registered. Selecting an original displaying tag displays a linkage original information on other page.

A web-data conversion switch for converting data into web-data is provided. Pushing the conversion switch converts the designated essay information into the HTML file, and a WEB-management page 84 is displayed, which presents the date of creating the HTML file, the name of the HTML file, the writer's name, the title, and the name of the person who opens the essay. The XSL style sheet 24 is used for converting the XML data table into the HTML file. It is desired to provide such the conversion switch into the web-data only on the administrator's page in the security viewpoint.

The MY LIST page 80 shown in FIG. 22 corresponds to the processes 48 for research and the process 62 for opening on the Web. The MY LIST page 80 may contribute to improve the research ability and the expression ability of the student and allows an effective use of the historical informations.

The descriptions will be made with reference to FIG. 11. In a step F2, a MASSAGE page 86 shown in FIG. 25 is displayed upon selecting the MESSAGE tag in the above-described steps A14 and A22. The MASSAGE page 86 includes a message list, a receipt tag, a transmitted tag, and a massage-creating tag. The message list displays the date of receipt, the sender's information and the title.

In a step F4, if a selecting signal for selecting the receipt tag is transmitted from a terminal to the present system, then the confirmation of the receipt of the new message and the message list display informations are transmitted to the terminal for displaying the same.

In a step F14, if a selecting signal for selecting the message list tag is transmitted from a terminal to the present system, then the information of displaying the contents of the received message is transmitted to the terminal for displaying the same.

Those transmission and receipt message data are registered on the message data table 22.

In a step F8, a selecting signal for selecting the transmitted tag is from a terminal to the present system, whereby a display information of the transmitted e-mail list is then transmitted to this terminal. A selecting signal for selecting the message tag is transmitted from a terminal to the present system, whereby a massage entry form information is transmitted to this terminal and a massage entry form is displayed.

In a step F10, an information entry is made into the massage entry form, whereby a transmission request signal is generated to transmit the entered information to a transmission destination.

The MASSAGE page 86 shown in FIG. 25 is a part of the edition process 42 shown in FIG. 5. The MASSAGE page 86 may contribute to improve the conversation ability 50 of the student.

The descriptions will be made with reference to FIG. 12. In a step G2, a RESULT page 88 shown in FIG. 26 is displayed upon selecting the RESULT tag in the above-described processes A12 and A22.

In a step G4, if the account is the teacher's account, then a class name selection list and a student name selection list are displayed in a step G6.

In a step G8, informations of selected class name and student name are transmitted to the present system, then a selected-student's record list 90 is displayed.

In the step G4, if the account is the student's account, then in a step G12, an essay record of this selected student is displayed. The displayed records may include, but not limited to, a comprehensive evaluation, another evaluation on the title, still another evaluation on the introductory remarks, yet another evaluation on the body, further another evaluation on the conclusion. Those evaluations may be made according to the evaluation items defined upon preparing the subject template.

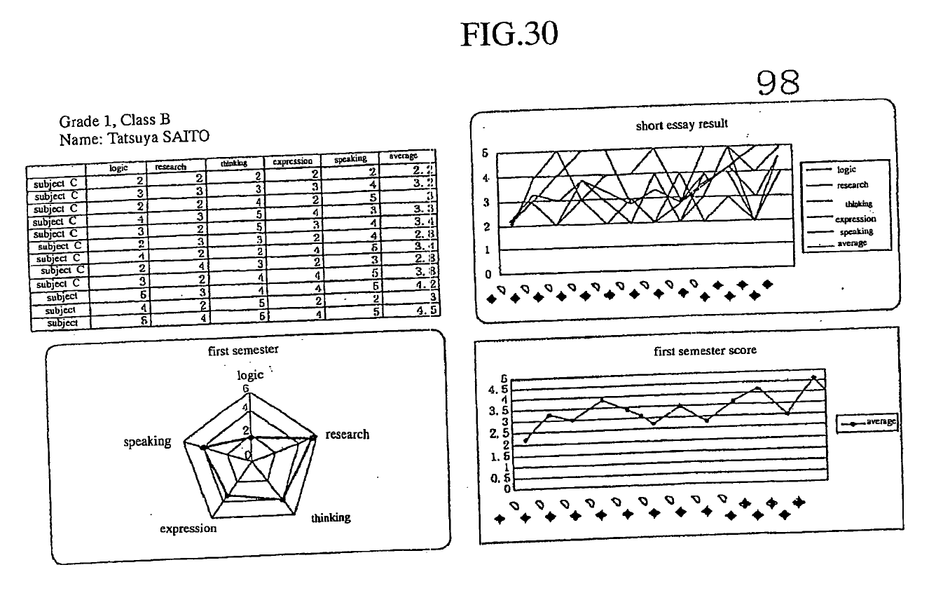

The RESULT page 88 shown in FIG. 26 corresponds to the evaluation 46 shown in FIG. 5. The RESULT page 88 may be referred to as the historical informations. The historical informations may be expressed on a table and a graph shown in FIG. 30.

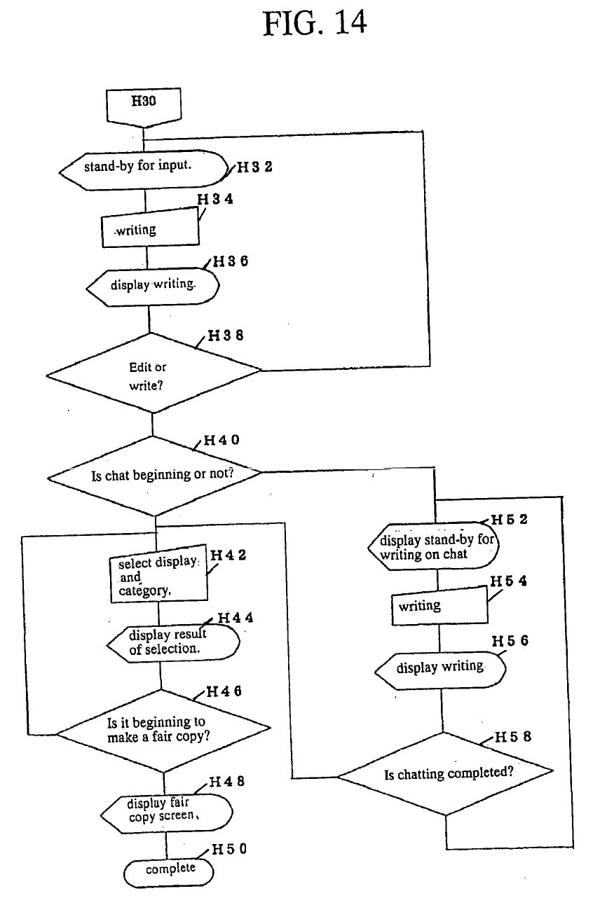

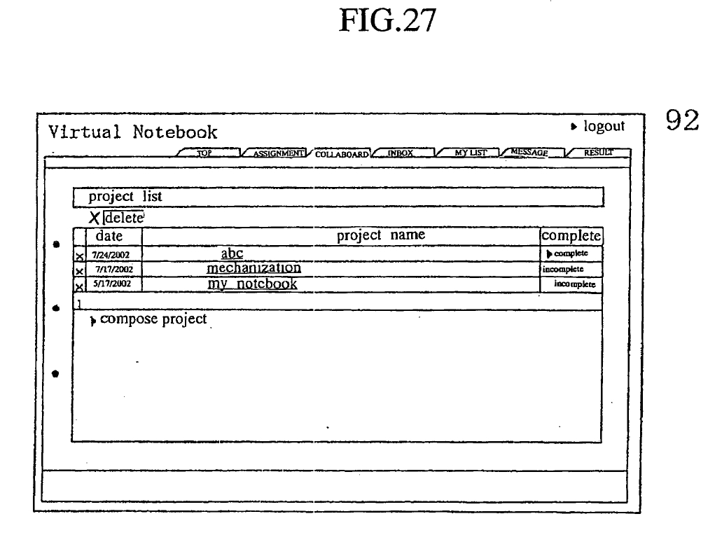

The descriptions will also be made with reference to FIGS. 13 and 14. In a step H2, a COLLABOLATION page 92 shown in FIG. 27 displays a project list 92 shown in FIG. 27 in each terminal upon selecting the COLLABOLATION tag in the above-described steps A14 and A22.

If the ID is of the teacher's account, then the project list page as the COLLABOLATION page 92 is provided with a project-creating switch. The project list page as the COLLABOLATION page 92 displays the project name, the project-started date, and a current status thereof.

In a step H14, the contents of the project are displayed upon selecting the project name.

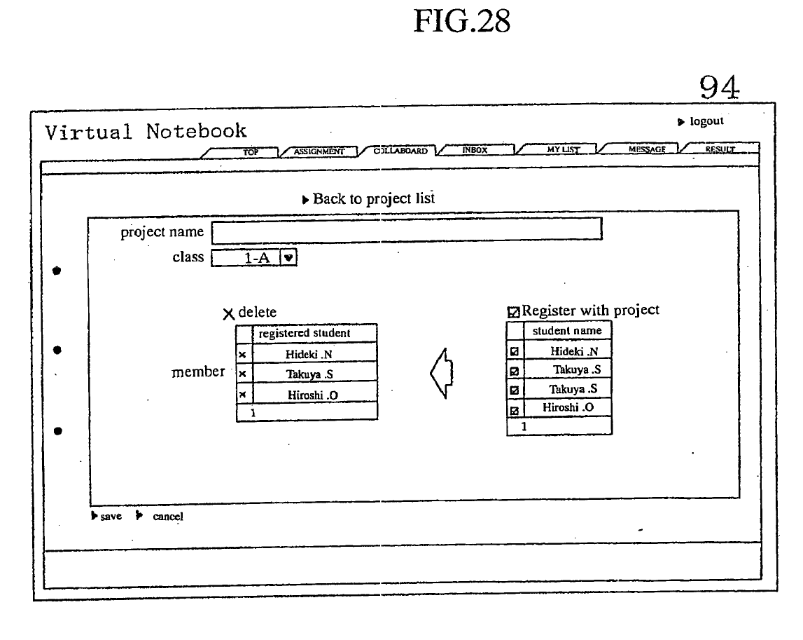

In a step H6, a project entry page 94 shown in FIGS. 13 and 28 is displayed on the teacher's terminal upon selecting the project-creating switch. The project entry page 94 allows entry of the project name and selection of the class and the registered student names. The entered project name and the selected class and strident names are saved or stored. The saved project informations are also displayed on the project list page 92.

In a step H8, the project entry page 94 allows optional edition of the existent project.

In a step H30, upon selecting the project name on the project list page 92, an entry stand-by page 96 is displayed on each of the connected terminals.

In a step H34, writing is made into an entry field from the each terminal.

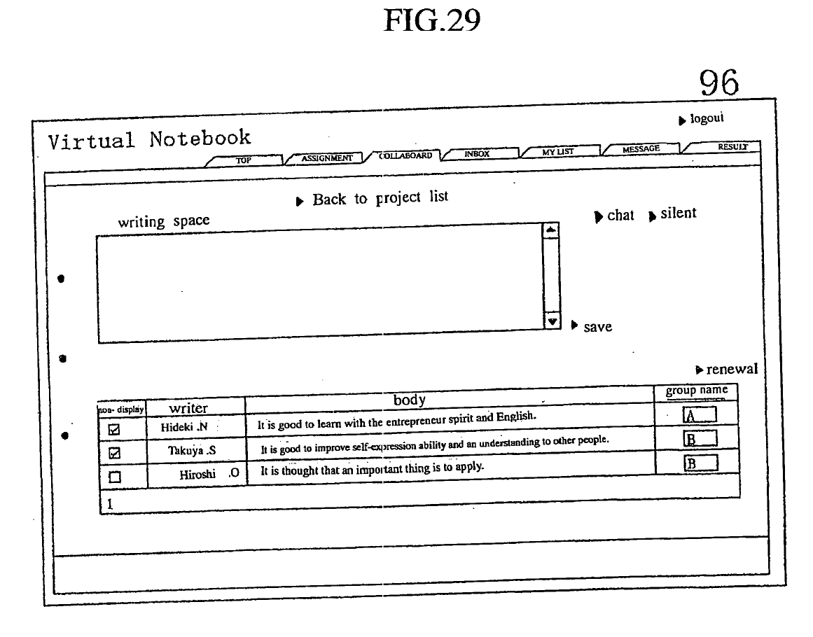

In a step H36, a written account name and a written content are displayed on the body item as shown in FIG. 29. Those written data are entered comment data. The written data are sequentially stored on the collaboration data table 20. If the writing process has been completed, then an edition process will start in a step H38. If the writing process has been completed, then the system remains in the stand-by state in the step H32.

In a step H40, a chat switch may effectively be used during the edition process.

In a step H42, a display selection function and a category selection function are provided during the edition process.

The display selection function may be activated through a non-display box shown in FIG. 29. A writing operation with selecting the non-display box does not display the information, so that an important written information may be selected without displaying substantially the same written information on the COLLABORATION page.

The category selection function is to classify the written information in view of the category, and display the classified information with a group name shown in FIG. 29. Each group name is given to each category. Plural informations are grouped by the same group name and displayed in the single group for organized display.

In a step H44, those selections have been made to display the selection results. Those selections may be made freely by any of the registered accounts for the project.

In a faire-copy selection, if the selected one is suitable for the fair-copy, then in a step H48, a fair-copy switch is selected, whereby a fair-copy page is displayed independently. The faire-copy page including the written informations are registered as an appropriate form onto the collaboration data table 20. The entered data through the faire-copy page are the faire-copy data. Selecting the faire-copy switch makes a conversion into the web-data for presentation or other data format for presentation.

If it is difficult that project members who should word the edition come together, then it is possible to select the chat switch shown in FIG. 29, so that in a step H52, upon selecting the chat switch, the terminal displays a chat-writing stand-by page for writing informations on the chat-writing stand-by page in a step H54, whereby the written information is displayed on each of the terminals in a step H56. A sufficient conversation through the chat has been made and completed to subsequently execute the edition process. The record of this chat may be recorded on the collaboration data table 20 upon selecting the fair-copy switch, and any overwrite to the record of this chat is inhibited.

The project may be registered through a project registration page 94 shown in FIG. 28. The project registration page 94 allows entries of the class name and the project member list to be registered on the collaboration data table 20.

Independent from the display or non-display, the entered comments of myself are registered on the MEMO item of the MY LIST. Each of the project data comprises the entered comment information, the chat information and the fair-copy information. The entered comment information provides the contents which are subject to the edition. The chat information provides the process. The fair-copy information provides a resultant information. Those informations are distinguishably stored in the data base to make it easy to post-refer the same for learning.

The COLLABOLATION page 92 shown in FIG. 27 corresponds to the edition 42 shown in FIG. 5. The COLLABOLATION page 92 may contribute to improve the research ability 48, the conversation ability 50 and the thinking ability 52 of the student.

The following descriptions will focus on respective pages corresponding to respective tags on the administrator's page.

Upon selecting an ACCOUNT tag, an ACCOUNT page 100 is displayed, which is shown in FIG. 31.

The ACCOUNT page 100 is a page for registration of the accounts. A typical example of the necessary items for registration may include, but not limited to, the respective kinds of teacher, student or administrator, the user's ID, family name and given name, memorandum, and password. Entries of those informations and subsequent selecting the save switch make a registration of those informations on the individual authentication data table 10. The registered account is displayed on the ACCOUNT page 100. The registered account also may optionally be edited or deleted.

Upon selection of a CLASS tag, a CLASS page 102 is displayed, which is shown in FIG. 32.

The CLASS page 102 is to make a linkage among the class information, the teacher's account and the student's account.

For the registered items on the CLASS page 102, the class name is linked to the teacher's account and then those inter-linked informations are registered on the individual authentication data table 10. A table of correspondences between the class names and the teacher's accounts is displayed on the CLASS page 102.

The student account of the registered class name on the ACCOUNT page 100 is selected and displayed on the registered student item. Further, a selection is made to the save switch over the ACCOUNT page 100 to register the student account on the individual authentication data table 10.

Upon selecting CSV UPLOAD tag, a CSV UPLOAD page 104 is displayed, which is shown in FIG. 33.

The CSV UPLOAD page 104 is to register a large number of accounts. The CSV UPLOAD page 104 uses the account data described in CSV format for storing the same on the individual authentication data table 10. The registered account data are available to teachers, students, classes and class members.

Upon selecting a TEMPLATE tag, a TEMPLATE page 106 is displayed, which is shown in FIG. 34.

The TEMPLATE page 106 is to create a template having continuous elemental items of essay in an optional sequence and an optional entry format.

A typical example of the entry items may include, but not limited to, the essay elements, a template name and an entry format.

A typical example of the selectable essay elements may include, but not limited to, “title”, “motivation”, “introduction”, “introductory remarks”, “body”, “conclusion” and “belonging”.

An optional name may be entered as the template name.

The template may also include items indicating a position of a cursor over the entry page, for example, “left-aligned template”, “center-aligned template”, and “right-aligned template”. Upon entry of an element into this frame, the template is configured in the order of entry. Those elements are entered to create the template, thereby making a student entry item, a teacher's evaluation text entry part, and a teacher's evaluation numeral entry part. Those templates are registered on the template XML data table 25. The registered template is displayed on the TEMPLATE page 106.

Upon selecting a MANAGEMENT tag, a MANAGEMENT page 108 is displayed, which is shown in FIG. 35.

The MANAGEMENT page 108 is to confirm transmitted and received teacher's data.

Upon entry of a teacher's name and a schedule, a class name, a student name, a student's submission date, a communication completed data, an evaluation and the number of edition are read out of the data registered on the message data table 22.

Upon selecting the CATEGORY tag, a CATEGORY page 110 is displayed, which is shown in FIG. 36.

The CATEGORY page 110 is to enter the category which should be entered on the ASSIGNMENT page 68.

Both the category name and the display order may be set for each of the vertical category and the horizontal category. Entered category data are registered as a base for entry into the subject XML data table 16. The entered category is also registered on the data base of the MY LIST.

Provision of the management pages allows optional creations of accounts and a variety of templates for making evaluations on the essay in view of each item.

Accordingly, the history of correction to the essay can be registered to allow a post-reference to the number of editions and the date of registration for utilizing the learning history, thereby allowing the learning-history informations to be re-useable, retrievable and storable, anywhere in cooperation with other students through the bulletin board, the chat and message functions.

Although the invention has been described above in connection with several preferred embodiments therefor, it will be appreciated that those embodiments have been provided solely for illustrating the invention, and not in a limiting sense. Numerous modifications and substitutions of equivalent materials and techniques will be readily apparent to those skilled in the art after reading the present application, and all such modifications and substitutions are expressly understood to fall within the true scope and spirit of the appended claims.

What is claimed is:

1. An educational method of utilizing a learning history information, said method including:
providing at least one student's account with at least one subject-related information, which has been classified in a designated field and registered in a data base;
providing at least one teacher's account with at least one student-prepared essay information with an edition-number-related information, which corresponds to said at least one subject-related information;
making a registration of said at least one student-created essay information into said data base, in combination with a teacher-providing evaluation record information and a designated-field-related information.

2. The method as claimed in claim 1, wherein elements constituting said at least one student-prepared essay information are distinguishably registered in said data base.

3. The method as claimed in claim 1, wherein said at least one student-prepared essay information is registered in an XML format into said data base.

4. The method as claimed in claim 1, further including:
converting said at least one student-prepared essay information into other format.

5. The method as claimed in claim 4, wherein said at least one student-prepared essay information is converted into an HTML format according to predetermined XSL data.

6. The method as claimed in claim 1, further including:
displaying at least one editable bulletin board.

7. The method as claimed in claim 6, wherein said at least one editable bulletin board enables selection of any one of display and non-display of contents of said at least one editable bulletin board and also re-ordering in accordance with a category classification.

8. The method as claimed in claim 7, wherein said at least one editable bulletin board has a project entry function of entering a teacher-decided project from said at least one teacher's account, and an access setting function of setting an access to said account.

9. The method as claimed in claim 6, wherein said at least one editable bulletin board enables a predetermined account to delete data, which have been written by a different account, from said at least one editable bulletin board.

10. The method as claimed in claim 6, wherein said teacher-providing evaluation record information is distinguishably registered for each item in said data base.

11. An educational system of utilizing a learning history information, said system including:
at least one web-server;
at least one application server electrically coupled to said at least one web-server; and
at least one data base server electrically coupled to said at least one web-server and said at least one application server,
wherein said at least one web-server is accessible to at least one teacher's terminal logged-in at a teacher's account and also to at least one student's terminal logged-in at a student's account, and
wherein said at least one application server includes:
a first function unit of providing at least one student's account with at least one subject-related information, which has been classified in a designated field and registered in said at least one data base server;
a second function unit of providing at least one teacher's account with at least one student-prepared essay information with an edition-number-related information, which corresponds to said at least one subject-related information; and
a third function unit of making a registration of said at least one student-created essay information into said at least one data base server, in combination with a teacher-providing evaluation record information and a designated-field-related information.

12. The system as claimed in claim 11, wherein elements constituting said at least one student-prepared essay information are distinguishably registered in said at least one data base server.

13. The system as claimed in claim 11, wherein said at least one student-prepared essay information is registered in an XML format into said at least one data base server.

14. The system as claimed in claim 11, further including:
a fourth function unit of converting said at least one student-prepared essay information into other format.

15. The system as claimed in claim 14, wherein said at least one student-prepared essay information is converted into an HTML format according to predetermined XSL data.

16. The system as claimed in claim 11, further including:
a fifth function unit of displaying at least one editable bulletin board.

17. The system as claimed in claim 16, wherein said at least one editable bulletin board enables selection of any one of display and non-display of contents of said at least one editable bulletin board and also re-ordering in accordance with a category classification.

18. The system as claimed in claim 17, further including:
a sixth function unit of entering a teacher-decided project onto said at least one editable bulletin board at said at least one teacher's account; and
a seventh function unit of setting an access to said account.

19. The system as claimed in claim 16, wherein said at least one editable bulletin board enables a predetermined account to delete data, which have been written by a different account, from said at least one editable bulletin board.

20. The system as claimed in claim 16, wherein said teacher-providing evaluation record information is distinguishably registered for each item in said at least one data base server.
